(19) United States
(12) Patent Application Publication
(10) Pub. No.: US 2025/0059359 A1
(43) Pub. Date: Feb. 20, 2025

(54) NEW REINFORCING ORGANIC FILLERS FOR ELASTOMERIC COMPOUNDS AND TYRES THAT COMPRISE THEM

(71) Applicant: Pirelli Tyre S.p.A., Milano (IT)

(72) Inventors: Luca GIANNINI, Milano (IT); Silvia GUERRA, Milano (IT); Luciano TADIELLO, Milano (IT); Maurizio GALIMBERTI, Milano (IT); Vincenzina BARBERA, Milano (IT); Lucia Rita RUBINO, Milano (IT)

(73) Assignee: Pirelli Tyre S.p.A., Milano (IT)

(21) Appl. No.: 18/721,113

(22) PCT Filed: Dec. 21, 2022
(86) PCT No.: PCT/IB2022/062591

§ 371 Date: Jun. 17, 2024

(30) Foreign Application Priority Data
Dec. 24, 2021 (IT) 102021000032633

(51) Int. Cl. C08L 7/00; B60C 1/00; B60C 11/00; C08G 18/10; C08G 18/28; C08G 18/32; C08G 18/76

(52) U.S. Cl. CPC C08L 7/00; B60C 1/0016; B60C 11/0008; C08G 18/10; C08G 18/2825; C08G 18/3206; C08G 18/7664; B60C 2011/0025

(57) ABSTRACT

The present invention relates to new polyurethane or polyurea organic reinforcing fillers for elastomeric tyre compounds, tyre components and tyres for vehicle wheels that comprise them. Advantageously these organic fillers allow reducing the weight of the elastomeric compounds that include them and confer to the materials a hysteresis that is in line or even lower, moduli stable at different temperatures, and high load/elongation at break.

The object of the present invention is new reinforcing organic fillers for elastomeric tyre compounds, tyres components and tyres for vehicle wheels that comprise them.

### STATE OF THE ART

The weight of the tyre is one of the relevant parameters in determining the fuel consumption of a car: the lighter the model, the lower the energy consumed by the car in order to be moved.

The weight of the tyre is the result of the design selections made by the designers and, in particular, strongly depends on the materials used for the internal structure.

The evolution in the world of tyres is clearly heading towards a gradual reduction of the overall weight thereof, i.e. towards tyres with a lower average fuel consumption, and hence higher energy efficiency.

Together with the weight, the rolling resistance, average fuel consumption and consequently the negative impact on the environment are also reduced.

In addition, the reduction of the masses can result in improved performances regarding braking, acceleration, steering precision, driving comfort and prolongation of the lifetime of the suspension components.

Therefore most of the producers are progressively reducing the weight of the tyres with each successive generation. This is translated not only into better performances but also lower costs of production, of the material and logistics.

There are various possible approaches for reducing the weight of the tyre and among these there is the recurring use of materials with lower specific weight, which however must ensure the maintenance of the performances.

In the tyre industry, it is known to add reinforcing fillers, typically inorganic, to the elastomeric compositions for the purpose of improving the mechanical properties thereof.

A good dispersion of the reinforcing fillers is an important requirement for obtaining compositions suitable for use in tyres. Indeed, a non-uniform dispersion, with formation of numerous and/or voluminous aggregates, negatively affects the performances of the material itself, for example resulting in an excessive hysteresis or in a poor breaking behaviour.

Due to its high reinforcing power, carbon black is the filler most commonly used. Carbon black confers significant hysteresis to manufactured products, i.e. it increases the heat dissipated in dynamic conditions.

Alternatively, the so-called “white” reinforcing fillers are in use, such as talc, kaolin, bentonite, titanium dioxide, and above all silica and silicates, also derivatised, fillers which can partially or completely substitute the carbon black in the elastomeric compositions and confer a lower rolling resistance to the tyres, a good grip on the wet and simultaneously a sufficient reinforcement.

These conventional fillers nevertheless significantly affect the specific weight of the compounds which incorporate them and, consequently, the final weight of the tyre. The Applicant, in order to reduce the weight of the tyre, has investigated the possibility of inserting organic fillers in the rubber, in particular polyurethane or polyurea organic fillers.

In the literature, there are several examples of compounds comprising mixtures of polyurethanes and elastomers, compounds which however have problems of compatibility—with poor breaking properties—and production, both due to the potential toxicity of the isocyanates and relative amines during the processing of the rubber, which requires the adaptation of the plants in order to protect the operators, and to the possible side-effect reactions of hydrolysis, so that the conventional mixing plants are not equipped to ensure anhydrous conditions.

For example, in the article “Blending In Situ Polyurethane-Urea with Different Kinds of Rubber: Performance and Compatibility Aspects” by Tahir et al (Materials 2018, 11, 2175), mixed PU-rubber systems are described that are prepared by adding the PU precursors (isocyanates in prepolymer form and diamines) to the rubber in the mixer and making them react directly in situ. The properties of the materials thus obtained, shown in Table 2, are not particularly promising.

In the article “Novel Design of Eco-Friendly Sufor elastomer Materials With Optimized Hard Segments Micro-Structure: Toward Next-Generation High-Performance Tires” by Qin X et al (Frontiers in Chemistry, 1 Jul. 2018, Volume 6, Article 240), polyurethanes comprising diene polymers such as hydroxy terminated SSBR as soft segment with molecular weight around 3000, instead of the conventional polyols, are described.

These polyurethanes do not appear suitable for an actual industrial application, both because the HO-SSBR-OH precursors cannot be easily synthesised and retrieved, and because the polyurethanes once prepared as described here (one-pot synthesis) can no longer be processed with the conventional techniques of the field. Indeed, in order to produce tyres, they would have to be directly synthesised in the mould, requiring the design of plants ad hoc.

The patent application WO2021/202635A1 describes the preparation of oligomers capable of dimerising due to the formation of multiple hydrogen bonds between specific terminal groups termed “UPy”. Suggested terminal groups UPy are the 2-ureido-4-pyrimidinones (page 5), derived from 2-amino pyrimidine like those listed in paragraph [012]. The exemplified oligomers (oligomers 1-17, para 75-92, Table 2) are typically asymmetric, i.e. terminated by reaction on one side with the amine 2-amino-4-hydroxy-6-methyl-pyrimidine (Table 1) (urea bond) and on the other side with an alcohol (urethane bond) and/or they have a polyol portion with generally high molecular weight, typically around 1000 g/mol. In the document, it is suggested to use these oligomers for covering optical fibres (para 53, 54).

### SUMMARY OF THE INVENTION

The Applicant—with the objective of reducing the weight of the tyre, its rolling resistance and finally consumptions on the road—has undertaken studies relative to new particular organic fillers, capable of supplying a reinforcing action comparable to that of the conventional fillers, maintaining analogous performances during use but simultaneously characterised by a lower weight.

For such purpose, the Applicant has considered the possibility of reinforcing the elastomeric compounds by means of organic fillers wherein the reinforcing effect is based on the rigid segments of polyurethane and/or polyurea structures.

Polyurethanes and polyureas (PU) belong to the class of copolymers with alternated blocks, where rigid segments and flexible segments alternate with each other along the chain. The flexible segments include the polyols, which typically can be polyethers or polyesters, or respectively polyamines, while the rigid segments are formed by residues of diisocyanates and polyols (o polyamines), with low molecular weight.

The PU have very interesting characteristics with high resistance to tearing and wear, attributable to the rigid segments, but they are poorly miscible with the rubbers used in the elastomeric tyre compounds and for such reasons are actually little used in the field.

The Applicant has instead studied organic fillers based on polyurethane or polyurethane oligomers, with few repeating units, containing rigid segments terminated with groups capable of interacting with the diene polymers of the rubber, which are well-dispersed and impart to the compound the advantageous mechanical properties of the PU, simultaneously allowing a reduction of the weight with respect to the conventional fillers.

These organic fillers, in addition to a reduced weight, also confer to the elastomeric compounds a hysteresis that is in line or lower, stable moduli at different temperatures, and high load/elongation at break.

The Applicant assumes that these optimal results depend on the urethane or urea segment of the present oligomers which, by formation of strong hydrogen bonds, pairs with analogous segments of other oligomers, generating a rigid phase, as occurs in the classic PU structures.

These multilayer structures would behave as conventional reinforcing fillers in normal stress conditions but would become plastic when the material is strongly stressed, without reaching breaking.

Finally, advantageously, the present organic fillers are potentially biodegradable.

Therefore, a first aspect of the present invention is constituted by a terminated (poly)urethane and/or (poly)urea oligomer (I) suitable as reinforcing material for an elastomeric tyre compound, wherein said terminated (poly)urethane and/or (poly)urea oligomer (I) can be obtained by reaction of
at least one polyisocyanate (II),
at least one polyol (III-I) and/or one polyamine (III-II) with molecular weight lower than 400 g/mol,
wherein polyisocyanate (II) and polyol (III-I) and/or polyamine (III-II) are used in the reaction in quantities such as to provide isocyanate groups and hydroxyl and/or amino groups in molar ratio of isocyanate groups to hydroxyl and/or amino groups comprised between 3:1 and 1.1:1, and to contribute no more than 5000 g/mol to the weight average molecular weight MW of the terminated oligomer (I), and
at least one monoalcohol or at least one monoamine of formula (IV)

X—Y—H (IV)
wherein
X represents an organic residue comprising at least one reactive group capable of covalently binding to the diene polymers of the elastomeric compound under vulcanisation conditions or at least one hydrophobic group with high affinity for said diene polymers;
Y represents —O— or —NR2— wherein R2 is selected from H and C₁-C₁₈, preferably C₁-C₆, linear or branched, saturated or unsaturated alkyl, possibly substituted C₅-C₆ cycloalkyl, an aromatic group, possibly substituted by one or more linear or branched C₁-C₁₈, preferably C₁-C₆, alkyls, a heteroaromatic group comprising from 1 to 3 heteroatoms, possibly substituted by one or more C₁-C₁₈, preferably C₁-C₆, 10 linear or branched, saturated or unsaturated alkyls,
wherein said terminated (poly)urethane and/or (poly)urea oligomer (I) has a weight average molecular weight MW lower than 25000 g/mol, measured by gel permeation chromatography (GPC).

In the present oligomer of formula (I) the Y groups are equal to each other and, preferably but not necessarily, also the X groups are equal to each other.

A further aspect of the present invention is represented by a composition for an elastomeric tyre compound comprising at least
100 phr of at least one diene polymer,
at least 1 phr of at least one terminated (poly)urethane and/or (poly)urea oligomer (I) as defined above, and
at least 0.1 phr of a vulcanising agent.

A further aspect of the present invention is represented by an elastomeric tyre compound obtained by mixing and vulcanising the composition according to the invention.

A further aspect of the present invention is represented by a tyre component for vehicle wheels comprising, or preferably constituted by the elastomeric compound according to the invention.

A further aspect of the present invention is represented by a tyre for vehicle wheels comprising at least one tyre component according to the invention.

A further aspect of the present invention is represented by the use of a terminated (poly)urethane and/or (poly)urea oligomer (I) according to the invention as a reinforcing material for an elastomeric tyre compound.

### BRIEF DESCRIPTION OF THE FIGURES

With reference to the enclosed figures:

FIG. 1 shows a tyre for vehicle wheels comprising at least one component comprising the elastomeric compound according to the invention;

FIG. 2 is the ¹H-NMR spectrum of the 2-(2,5-dimethyl-1H-pyrrol-1-yl)ethan-1-ol (IV-A) prepared in Example 1;

FIG. 3 is the IR spectrum of the oligomer (I-A) prepared in Example 2;

FIG. 4 is the IR spectrum of the oligomer (I-B) prepared in Example 3;

FIG. 5 and FIG. 6 are respectively the IR spectrum and ¹H-NMR spectrum of the oligomer (I-C) prepared in Example 4 (idealised structure referred to a pure di-isocyanate n=1);

FIG. 7 and FIG. 8 are respectively the ¹H-NMR spectrum and IR spectrum of the oligomer (I-D) prepared in Example 5 (idealised structure referred to a pure di-isocyanate n=1)

FIG. 9 and FIG. 10 are respectively the ¹H-NMR spectrum and IR spectrum of the oligomer (I-E) prepared in Example 6 (idealised structure referred to a pure di-isocyanate n=1);

FIG. 11 and FIG. 12 are respectively the IR spectrum and ¹H-NMR spectrum of the oligomer (I-B) prepared in Example 10 (idealised structure referred to a pure di-isocyanate, n=1);

FIG. 13 and FIG. 14 are respectively the IR spectrum and ¹H-NMR spectrum of the oligomer (I-G) prepared in Example 12.

### DETAILED DESCRIPTION OF THE INVENTION

A first aspect of the present invention is represented by a terminated (poly)urethane and/or (poly)urea oligomer (I) suitable as reinforcing material for an elastomeric tyre compound.

In the present description, with the term “oligomer” a compound having weight average molecular weight MW lower than 25000 g/mol, measured by gel permeation chromatography is meant.

With the term “(poly)urethane and/or (poly)urea oligomer” an oligomer comprising one or more urethane repeating units and/or one or more urea repeating units is herein meant.

With the term “terminated (poly)urethane and/or (poly)urea oligomer” a (poly)urethane and/or (poly)urea oligomer as defined above which bears terminal groups X—Y— wherein groups Y are equal to each other and, preferably but not necessarily, also the groups X are equal to each other is meant.

Therefore, the terminated oligomer of formula (I) of the present invention is terminated by reaction with one or more alcohols X—OH, as subsequently defined, more preferably with only one alcohol X—OH. Alternatively, it is terminated by reaction with one or more X—NHR2 amines, as subsequently defined, more preferably with only one XNHR2 amine. Therefore, the terminated (poly)urethane and/or (poly)urea oligomer (I) suitable as reinforcing material for the elastomeric tyre compound of the invention can be obtained by reaction of
at least one polyisocyanate (II),
at least one polyol (III-I) and/or one polyamine (III-II) with molecular weight lower than 400 g/mol,
wherein polyisocyanate (II) and polyol (III-I) and/or polyamine (III-II) are used in the reaction in quantities such as to provide isocyanate groups and hydroxyl and/or amino groups in molar ratio of isocyanate groups to hydroxyl and/or amino groups comprised between 3:1 and 1.1:1, and to contribute no more than 5000 g/mol to the weight average molecular weight MW of the terminated oligomer (I), and
at least one monoalcohol or at least one monoamine of formula (IV)

X—Y—H (IV)
wherein
X, equal to or different from each other, preferably equal, represent an organic residue comprising at least one reactive group capable of covalently binding to the diene polymers of the elastomeric compound under vulcanisation conditions or at least one hydrophobic group with high affinity for said diene polymers;
Y, equal to each other, represent —O— or —NR2— wherein R2 is selected from H, C₁-C₁₈, preferably C₁-C₆, linear or branched, saturated or unsaturated alkyl, possibly substituted C₅-C₆ cycloalkyl, an aromatic group, possibly substituted by one or more linear or branched C₁-C₁₈, preferably C₁-C₆, alkyls, a heteroaromatic group comprising from 1 to 3 heteroatoms, possibly substituted by one or more C₁-C₁₈, preferably C₁-C₆, linear or branched, saturated or unsaturated alkyls,
wherein said terminated (poly)urethane and/or (poly)urea oligomer (I) has a weight average molecular weight MW lower than 25000 g/mol measured by gel permeation chromatography.

In a preferred embodiment the present invention relates to a terminated (poly)urethane oligomer (I) suitable as reinforcing material for an elastomeric tyre compound, wherein said terminated (poly)urethane oligomer (I) has a weight average molecular weight MW lower than 25000 g/mol, measured by gel permeation chromatography, and can be obtained by reaction of:
at least one polyisocyanate (II),
at least one polyol (III-I) with molecular weight lower than 400 g/mol,
wherein polyisocyanate (II) and polyol (III-I) are used in the reaction in quantities such as to provide isocyanate groups and hydroxyl groups in molar ratio of isocyanate groups to hydroxyl groups comprised between 3:1 and 1.1:1, and to contribute no more than 5000 g/mol to the weight average molecular weight MW of the terminated oligomer (I), and
at least one monoalcohol of formula (IV-I)

X—O—H (IV-I)
wherein
X represents an organic residue comprising at least one reactive group capable of covalently binding to the diene polymers of the elastomeric compound under vulcanisation conditions or at least one hydrophobic group with high affinity for said diene polymers.

In this preferred embodiment, the at least one polyol (III-I) preferably has molecular weight lower than 200 g/mol, more preferably lower than 154 g/mol, still more preferably lower than 120 g/mol or 100 g/mol.

The terminated (poly)urethane and/or (poly)urea oligomer (I) according to the invention is preferably characterised by a weight average molecular weight MW lower than 20000 g/mol, preferably lower than 10000 g/mol, more preferably lower than 7000 g/mol, still more preferably lower than 5000 g/mol or 4000 g/mol.

In one embodiment, preferably the terminated (poly)urethane and/or (poly)urea oligomer (I) of the invention has a weight average molecular weight greater than 300 g/mol, more preferably greater than 500 g/mol, still more preferably greater than 700 g/mol.

In one embodiment, preferably the terminated (poly)urethane and/or (poly)urea oligomer (I) of the invention has a weight average molecular weight comprised between 20000 g/mol and 300 g/mol, more preferably between 10000 g/mol and 500 g/mol, still more preferably between 5000 g/mol and 700 g/mol.

In one embodiment, the terminated (poly)urethane and/or (poly)urea oligomer (I) of the invention has a weight average molecular weight comprised between 5000 g/mol and 25000 g/mol, preferably between 5000 g/mol and 12000 g/mol.

The weight average molecular weight of the terminated (poly)urethane and/or (poly)urea oligomer (I) and of the intermediate non-terminated (poly)urethane (V-I) and/or (poly)urea (V-II) oligomer as defined below, can be determined, after isolation by gel permeation chromatography (GPC), as described in the present experimental part.

The terminated (poly)urethane and/or (poly)urea oligomer (I) according to the invention is preferably characterised by a density lower than 1.40 g/cm³, more preferably lower than 1.25 g/cm³, measurable as described in the present experimental part.

With respect to the densities of the conventional fillers, which typically for example for the silica can be around 2.0 g/cm³ and for the carbon black 1.80 g/cm³, the density of the filler of formula (I) according to the invention is significantly lower, allowing once incorporated a significant reduction of the weight of the compound.

With the term “conventional filler” a reinforcing material typically used in the field for improving the mechanical properties of tyres, e.g. carbon black, possibly modified, and white fillers such as gypsum, talc, kaolin, bentonite, titanium dioxide, silica and silicates, also derivatised or modified by acid treatment is meant.

The terminated (poly)urethane and/or (poly)urea oligomer (I) according to the invention can be obtained by reaction of
at least one polyisocyanate (II),
at least one polyol (III-I) and/or one polyamine (III-II) and
at least one monoalcohol or at least one monoamine (IV).

Polyisocyanate (II) suitable for the preparation of the terminated (poly)urethane and/or (poly)urea oligomer (I) according to the invention can comprise two or more isocyanate groups —NCO, preferably from 2 to 5, more preferably from 2 to 4.

Polyisocyanate (II) can be aliphatic, aromatic or aromatic-aliphatic.

The polyisocyanates (II) preferred in the context of the present invention are diisocyanates.

The aliphatic diisocyanates used are conventional aliphatic and/or cycloaliphatic diisocyanates, for example diisocyanate of tri, tetra, penta, hexa, hepta- and/or octamethylene, 2-methylpentamethylene 1,5-diisocyanate, 2-ethyltetramethylene 1,4-diisocyanate, hexamethylene 1,6-diisocyanate (DI), pentamethylene 1,5-diisocyanate, butylene 1,4-diisocyanate, trimethyl hexamethylene 1,6-diisocyanate, 1-isocyanate-3,3,5-trimethyl-5-isocyanate methylcyclohexane (isophorone diisocyanate, IPDI), 1,4- and/or 1,3-bis(isocyanate methyl)cyclohexane (XDI), cyclohexane 1,4-diisocyanate, 1-methyl-2,4- and/or 1-methylcyclohexane 2,6-diisocyanate, methylene dicyclohexyl 4,4′- and/or 2,2′-diisocyanate (HMDI) and mixtures thereof.

Preferred aliphatic polyisocyanates (II) are pentamethylene 1,5 diisocyanate, hexamethylene 1,6-diisocyanate (HDI), isophorone di-isocyanate (IPDI) and methylene dicyclohexyl 4,4′, 2,4′- and/or 2,2′-diisocyanate (HMDI) and mixtures thereof.

Suitable aromatic diisocyanates are for example 1,5-naphthylene diisocyanate (NDI), 2,4- and/or 2,6-tolylene diisocyanate (TDI), 2,2′, 2,4′- and/or 4,4′-diphenylmethane diisocyanate (MDI), 3,3′-dimethyl-4,4′-diisocyanate diphenyl (TODI), p-phenylene diisocyanate (PDI), diphenylethane 4,4′-diisocyanate (EDI), diphenylmethane diisocyanate, 3,3′-dimethyldiphenyl diisocyanate, diphenylethane 1,2-diisocyanate, phenylene diisocyanate and mixtures thereof.

In the following Table 1, several suitable diisocyanates and the relative CAS numbers are reported:

TABLE 1

| Name | CAS Mo. |
|---|---|
| 2-methyl-m-phenylene diisocyanate | 91-08-7 |
| 3,3′-dimethylbiphenyl-4,4′-diyl diisocyanate | 91-97-4 |
| 4,4′-Methylenediphenyl diisocyanate | 101-68-8 |
| hexamethylene diisocyanate | 822-06-0 |
| 4-methyl-m-phenylene diisocyanate | 584-84-9 |
| 4,4′-methylene dicyclohexyl diisocyanate | 5124-30-1 |
| m-tolylidene diisocyanate | 26471-62-5 |
| 2,4,6-triisopropyl-m-phenylene diisocyanate | 2162-73-4 |
| 2,2′-Methylenediphenyl diisocyanate | 2536-05-2 |
| 1,3-bis(1-isocyanate-1-methyethyl)benzene | 2778-42-9 |
| 1,5-naphthylene diisocyanate | 3173-72-6 |
| 1,3-bis(isocyanatemethyl)benzene | 3634-83-1 |
| 3-isocyanatemethyl-3,5,5-trimethylcyclohexyl isocyanate | 4098-71-9 |
| 2,4′-Methylenediphenyl diisocyanate | 5873-54-1 |

In a preferred embodiment polyisocyanate (II) is selected from the group comprising methylene diphenyl diisocyanate (MDI), tolylene 2,4- and/or 2,6-diisocyanate (TDI), hexamethylene 1,6-diisocyanate (HDI), pentamethylene 1,5-diisocyanate, methylene dicyclohexyl 4,4′, 2,4′- and/or 2,2′-diisocyanate (HMDI), isophorone diisocyanate (IPDI) and mixtures thereof.

According to one embodiment of the invention, polyisocyanate (II) used for the preparation of the terminated oligomer (I) can be partially pre-polymerised and used in the form of composition comprising oligomers of the polyisocyanate (II), also in mixture with monomer polyisocyanate (II).

An example of suitable partially pre-polymerised isocyanate is the following oligomer of MDI

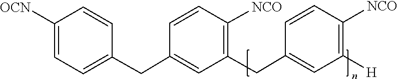

Commercial examples of suitable partially pre-polymerised polyisocyanates (II) are the pre-polymers based on HDI, on IPDI, on TDI or on MDI of the Desmodur® series by Covestro, VORALAST™ and hyPERLAST™ by DOW, Lupranat@ and ISO 137 by BASF.

Preferably the pre-polymers of suitable polyisocyanates have a content of NCO approximately from 7 to 45%, preferably from 10 to 35%, more preferably from 17 to 27% by weight.

In the preparation of the present terminated oligomer (I), the composition comprising oligomers of the polyisocyanate (II) is used in a quantity such as to bring to the system m*f moles of isocyanate groups, where m is a number comprised between 2 and 5, preferably between 2 and 4, which represents the number of moles of polyisocyanate (II) used in the reaction, and f is the average number of isocyanate groups per molecule in the polyisocyanate (II), f being typically comprised between 1.8 and 4, preferably between 1.9 and 3, more preferably between 1.8 and 2.2.

Examples of oligomers are also those obtainable by partial reaction of the diisocyanates with water, for example the biurets of the aforesaid diisocyanates.

Examples of polyisocyanates (II) with higher functionality are the triisocyanates, for example triphenylmethane 4,4′,4″-triisocyanate and also the cyanurates of the aforesaid diisocyanates.

Polyol (III-I) and/or polyamine (III-II) with molecular weight lower than 400 g/mol, preferably lower than 200 g/mol, more preferably lower than 154 g/mol, still more preferably lower than 120 g/mol or 100 g/mol, suitable for the preparation of the terminated (poly)urethane and/or (poly)urea oligomer (I) of the invention can comprise two or more hydroxyl or amino groups respectively.

Preferably polyol (III-I) and polyamine (III-II) have a molecular weight comprised between 60 and 200 g/moles, more preferably between 60 and 150 g/mol, in the case of the polyol (III-I), and between 70 and 300 g/mol, in the case of the polyamine (III-II).

Polyol (III-I) and polyamine (III-II) can be respectively a mixture of two or more polyols and two or more polyamines.

In one embodiment, the agent (III) is a mixture of one or more polyols and one or more polyamines.

In a preferred embodiment, the agent (III) is a polyol.

Examples of preferred polyols are the diols of formula (III-I)

HO—R1—OH
wherein R1 represents C₂-C₈, preferably C₂-C₆, linear or branched alkylene, such as for example ethylene glycol, 1,3-propanediol, 1,4-butanediol and the like, and mixtures thereof.

Examples of polyols (III-I) C₃-C₁₀ with more than 2 OH groups are glycerol, pentaerythritol and mixtures thereof.

Preferably polyol (III-I) does not contain sulphur or other heteroatoms which are not oxygen.

Preferably polyol (III-I) is different from HO—(CH₂)₂—S—S—(CH₂)₂—OH.

In one embodiment, diols and polyols are used with more than 2 OH groups in mixture. In such case preferably the quantity of polyols is such as to provide not more than 20% of the hydroxyls of the mixture.

In one embodiment, the agent (III) is a polyamine having at least two primary and/or secondary amino groups.

Preferably polyamine (III-II) comprises two or more NH2 groups (primary amine).

In one embodiment, polyamine (III-II) is a diamine.

In one embodiment, polyamine (III-II) comprises two or more secondary amino groups of formula —NHR2 wherein R2 is selected from C₁-C₁₈, preferably C₁-C₆, linear or branched, saturated or unsaturated alkyl, possibly substituted C₅-C₆ cycloalkyl, an aromatic group, possibly substituted by one or more linear or branched C₁-C₁₈, preferably C₁-C₆ alkyls, a heteroaromatic group comprising from 1 to 3 heteroatoms, possibly substituted by one or more C₁-C₁₈, preferably C₁-C₆, linear or branched, saturated or unsaturated alkyls.

Examples of suitable aromatic group are systems with carbocyclic rings, monocyclic rings and aromatic polycyclic rings, in which the single carbocyclic rings are melted or attached to each other by means of a single bond, preferably C₆-C₂₀ or C₆-C₁₀ systems, for example selected from phenyl, biphenyl, naphthyl, fluorenyl and phenantryl.

Examples of suitable heteroaromatic group are there heterocycles selected from pyrrole, furan, benzofuran, isobenzofuran, thiophene, benzothiophene, thiazole, thiadiazole, triazole, benzotriazole, tetrazole, isothiazole, imidazole, benzoimidazole, oxazole, benzoxazole, isoxazole, oxadiazole, pyrazole, benzopyrazole, pyridine, piperdine, piperazine, pyrazine, piridazine γ-piran, 1,4-dioxane, benzo-1,4-dioxane, morpholine, thiomorpholine pyrazine, quinoline, isoquinoline, indole, isoindole, pyrimidine, quinazoline, quinoxaline and the like.

Examples of preferred polyamines are 2,2′-dimethyl-4,4′-methylenebis (cyclohexylamine), 4,4′-methylene-bis(ortho-chloroaniline), ethylene diamine, isophorone diamine, 1,4-butandiamine and diaminopropane.

The monoalcohol and the monoamine of formula (IV)

X—Y—H (IV)

suitable for the preparation of the terminated (poly)urethane and/or (poly)urea oligomer (I) of the invention does not comprise other functional groups reactive with the isocyanate function beyond the single group —Y—H, i.e. they comprise a single group OH or NHR2 respectively.

In a preferred embodiment, the agent (IV) is a monoalcohol, of formula

X—O—H (IV-I)

The organic residue X of the alcohol of formula (IV-I) comprises a reactive group capable of covalently binding to the diene polymers of the elastomeric compound or a group similar to elastomers, capable of compatibilising the polyurethane portion with the diene polymer.

With the term “reactive group capable of being bonded to diene polymers” a functional group capable of forming covalent bonds with the diene polymer of the elastomeric compound during the vulcanisation of the same, typically carried out at temperatures comprised between 140°° C. and 190° C. and for times from 3 minutes to 60 minutes is meant.

The reactive group of the organic residue X can react directly with the double bonds of the diene polymer of the compound or can interact with the vulcanisation system, for example with sulphur base, and by means of this be bonded to the diene polymer.

In one embodiment, the organic residue X can contain an unsaturated residue containing double bonds, preferably activated with regard to the typical reactions of the vulcanisation process, such as vinyls, allyls, double conjugated bonds with electron-attractor groups, such as for example in the methacryl residue.

For example, the organic residue X can comprise a residue selected from possibly substituted C₂-C₁₈ alkene, preferably conjugated C₄-C₂₂ diene, C₆-C₂₄ polyene, for instance derived from polyunsaturated fatty acids or from terpenes, an oligomer derived from the oligomerisation of at least one diene and, possibly, at least one monounsaturated comonomer, for example butadiene and styrene and/or isoprene, with molecular weight comprised between 200 and 5000 g/mol, preferably between 300 and 3000 g/mol.

In one embodiment, the organic residue X comprises as reactive group at least one heterocycle, reactive with the polymer or with the vulcanisation system during vulcanisation, in particular a pyrrole, preferably substituted with methyls in the positions close to the nitrogen capable of reacting with the sulphur vulcanisation system and by means of the latter with the diene polymer, or a tetrazole, preferably substituted with aromatic groups in position 2 and 5.

The terminal groups UPy shown in WO2021/202635A1 such as the 2-ureido-4-pyrimidinones do not correspond with the category of the reactive heterocycles as intended herein, since they are unable to form, under vulcanisation conditions, significant covalent bonds with the diene polymer, directly or by means of the vulcanisation system.

In one embodiment, the organic residue X can include at least one reactive sulphur group, for example selected from SH, S—S, —Sₙ—, —S—(CO)— capable of being bonded directly with the diene polymer during vulcanisation of the compound.

Examples of suitable reactive alcohols (IV-I) are ethanolpyrrol (IV-A)

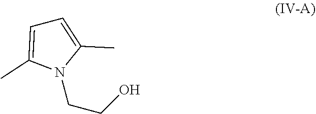

whose preparation is described herein at Example 1,
the geraniol of formula (IV-B)

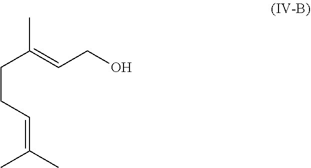

the 4(vinyloxy)butan-1-ol of formula CH₂═CH—O—(CH₂)₄—OH (IV-C)
the lipoic alcohol, the thiopropionic alcohol and its derivates as thioesters and the like.

With the term “hydrophobic group with high affinity for the diene polymers” an organic group with polarity comparable to that of the diene polymer and therefore capable of rendering the terminated (poly)urethane and/or (poly)urea oligomer (I) dispersible in the diene polymer is meant.

Preferably the hydrophobic group X is a group selected from linear or branched in the alkyl portion, possibly substituted, C₆-C₂₄ alkyl, C₆-C₁₈ aryl, C₆-C₁₀ aryl —C₁-C₄ alkyl —C₆-C₁₀ aryl, C₁-C₈ alkyl —C₆-C₁₀ aryl —C₁-C₈ alky.

More preferably the hydrophobic group X is an alkyl derived from fatty acids, such as octyl, iso-octyl, decyl, dodecyl.

Examples of hydrophobic alcohols (IV-I) are octyl alcohol, iso-octyl alcohol, hexyl alcohol, decyl alcohol and dodecyl alcohol.

The organic residue X can contain one or more of the abovementioned functions in combination. For example the organic residue X can simultaneously be capable of covalently binding to the diene polymers and being hydrophobic, such as for example the group derived from geraniol.

In one embodiment, the agent (IV) is a monoamine of formula

X—NH—R2 (IV-II)
wherein X takes on the above-reported definition and R2 is H (primary amine) or wherein R2 represents C₁-C₁₈, preferably C₁-C₆, linear or branched, saturated or unsaturated alkyl, possibly substituted C₅-C₆ cycloalkyl, an aromatic group, possibly substituted by one or more linear or branched C₁-C₁₈, preferably C₁-C₆, alkyls, a heteroaromatic group comprising from 1 to 3 heteroatoms, possibly substituted by one or more C₁-C₁₈, preferably C₁-C₆, linear or branched, saturated or unsaturated alkyls (secondary amine), preferably R2 is selected from H and linear or branched, saturated or unsaturated C₁-C₄ alkyl.

Preferably, the agent (IV) is a monoamine different from 2-amino-4-hydroxy-6-methyl pyrimidine, more preferably it is different from the amines of formula (IV-III)

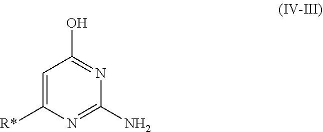

wherein R* represents hydrogen, methyl, ethyl, propyl, butyl, hexyl, octyl or 2-hydroxyethyl.

Examples of suitable monoamines are dodecylamine, hexylamine or the oligomers of butadiene, possibly copolymerised with styrene, terminated with an amino group. In a preferred embodiment the terminated (poly)urethane oligomer (I) is an oligomer of formula (I-I)

X—Y—[(C═O)—NH—R—NH—(C═O)—O—R1—O]ₙ—(C═O)—NH—R—NH—(C═O)—Y—X (I-I)
wherein
X, equal to or different from each other, preferably equal, represent an organic residue comprising at least one reactive group capable of covalently binding to the diene polymers of the elastomeric compound under vulcanisation conditions or at least one hydrophobic group with high affinity for the diene polymers;
Y, equal to each other, represent —O— or —NR2— wherein R2 is selected from H and C₁-C₁₈, preferably C₁-C₆, linear or branched, saturated or unsaturated alkyl, possibly substituted C₅-C₆ cycloalkyl, an aromatic group, possibly substituted by one or more linear or branched C₁-C₁₈, preferably C₁-C₆ alkyls, a heteroaromatic group comprising from 1 to 3 heteroatoms, possibly substituted by one or more C₁-C₁₈, preferably C₁-C_{6,} linear or branched, saturated or unsaturated alkyls;
R represents C₂-C₁₄ alkylene, C₆-C₁₈ arylene, C₆-C₁₀ arylene —C₁-C₄ alkylene —C₆-C₁₀ arylene, C₁-C₄ alkylene —C₆-C₁₀ arylene —C₁-C₄ alkylene, linear, branched or cyclic in the alkylene portion, or mono or bi-cyclic, saturated, unsaturated or aromatic, possibly benzocondensed, possibly substituted heterocyclyl with 5 or 6 members,, comprising at least one heteroatom selected from N, S and O, or mixtures thereof;
R1 represents linear or branched C₂-C₈, preferably C₂-C₆ alkylene, C₅-C₆ cycloalkylene, or mixtures thereof; and
n represents a number from 1 to 5.

In a more preferred embodiment, the terminated oligomer (I) of the invention is a terminated (poly)urethane oligomer of formula (I-II)

X—O—[(C═O)—NH—R—NH—(C═O)—O—R1—O]ₙ—(C═O)—NH—R—NH—(C═O)—O—X (I-II)
wherein preferably
the organic residues X are equal to each other, and comprise a heterocycle, preferably a pyrrole or a tetrazole, or an unsaturated residue, preferably a diene C₄-C₂₂, possibly substituted,
R represents linear or branched in the alkylene portion, possibly substituted C₂-C₁₄ alkylene or cycloalkylene, C₆-C₁₈ arylene, C₆-C₁₀ arylene —C₁-C₄ alkylene —C₆-C₁₀ arylene, C₁-C₄ alkylene —C₆-C₁₀ arylene —C₁-C₄ alkylene
R1 represents a linear or branched C₂-C₆ alkylene; and
n represents a number from 1 to 3.

More preferably, R represents a possibly substituted C₃-C₁₃ alkylene, a phenylene or a diphenylenemethane.

More preferably n represents a number from 1 to 2.

In one embodiment, the oligomer (I) is an oligomer of formula

X—O—[(C═O)—NH—R—NH—(C═O)—O—(CH₂)₄—O]₁₋₃—(C═O)—NH—R—NH—(C═O)—O—X (I-IIa)
wherein
X, equal to or different from each other, preferably equal, represent an organic residue comprising at least one reactive group capable of covalently binding to the diene polymers of the elastomeric compound under vulcanisation conditions or at least one hydrophobic group with high affinity for the diene polymers, and
R represents C₂-C₁₄ alkylene, C₆-C₁₈ arylene, C₆-C₁₀ arylene —C₁-C₄ alkylene —C₆-C₁₀ arylene, C₁-C₄ alkylene —C₆-C₁₀ arylene —C₁-C₄ alkylene, linear, branched or cyclic in the alkylene portion, or mono or bicyclic, saturated, unsaturated or aromatic, possibly benzocondensed possibly substituted heterocyclyl with 5 or 6 members, comprising at least one heteroatom selected from N, S and O, or mixtures thereof.

In one embodiment, the oligomer (I) is an oligomer of formula

X—O—[(C═O)—NH—(CH₂)₆—NH—(C═O)—O—(CH₂)₄—O]₁₋₃—(C═O)—NH—(CH₂)₆—NH—(C═O)—O—X (I-IIb)
wherein X equal to or different from each other, preferably equal, represent an organic residue comprising at least one reactive group capable of covalently binding to the diene polymers of the elastomeric compound under vulcanisation conditions or at least one hydrophobic group with high affinity for the diene polymers.

In one embodiment, the oligomer (I) is an oligomer of formula

X—O—[(C═O)—NH—C₆H₄—CH₂—C₆H₄—NH—(C═O)—O—(CH₂)₄—O]₁₋₃—(C═O)—NH—C₆H₄—CH₂—C₆H₄—NH—(C═O)—O—X (I-IIc)
wherein X equal to or different from each other, preferably equal, represent an organic residue comprising at least one reactive group capable of covalently binding to the diene polymers of the elastomeric compound under vulcanisation conditions or at least one hydrophobic group with high affinity for the diene polymers.

In one embodiment, the oligomer (I) is an oligomer of formula

X—O—[(C═O)—NH—R—NH—(C═O)—O—(CH₂)₄—O]₁₋₃—(C═O)—NH—R—NH—(C═O)—O—X (I-IId)
wherein X are equal to each other, and represent a heterocycle, preferably a pyrrole or a tetrazole, or an unsaturated residue, preferably a C₄-C₂₂ diene, possibly substituted and R has the above-reported definitions.

In a particularly preferred embodiment, in the oligomer of formula (I-II):
X represents an organic residue derived from geraniol or from ethanolpyrrol;
R represents a —(CH₂)₆— group or -phenyl-CH₂-phenyl-;
R1 represents a —(CH₂)₄— group; and
n represents 1 or 2.

Specific examples of oligomers of formula (I) are the following:

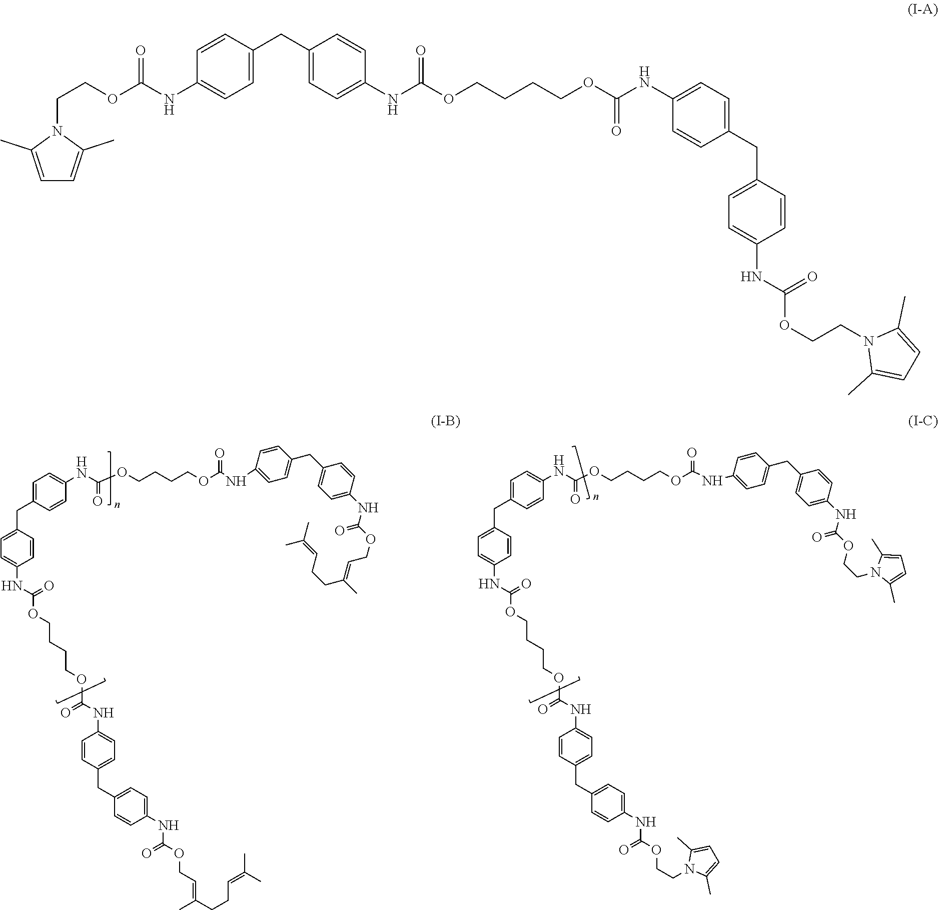

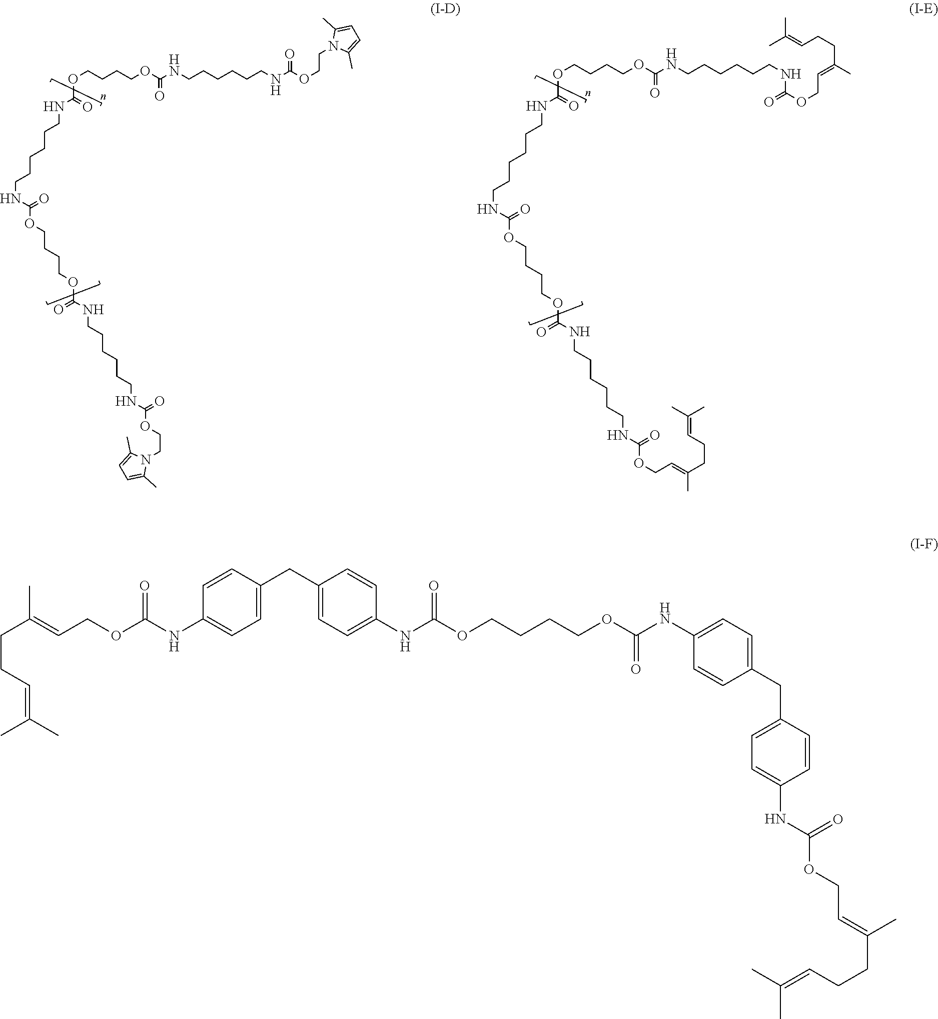

By suitably selecting the substituents X, R, R1 and n of the terminated (poly)urethane and/or (poly)urea oligomer (I), it is possible to modulate its dispersibility in the polymeric phase and the magnitude of the association of the rigid segments of the oligomer itself.

The terminated (poly)urethane and/or (poly)urea oligomer (I) suitable as reinforcing material for an elastomeric tyre compound of the invention can be prepared by reacting at least one polyisocyanate (II), at least one polyol (III-I) and/or one polyamine (III-II) with molecular weight lower than 400 g/mol and at least one monoalcohol or at least one monoamine (IV), according to conventional field procedures.

In the preparation of the terminated (poly)urethane and/or (poly)urea oligomer (I), the at least one monoalcohol or the at least one monoamine of formula (IV) are used in molar quantity at least equal to the difference between the moles of the isocyanate groups brought by the at least one polyisocyanate (II) and the total moles of hydroxyl and/or amino groups, primary and/or secondary, brought by the at least one polyol (III-1) and/or polyamine (III-II).

In a preferred embodiment, in the preparation of the terminated (poly)urethane oligomer (I-1), polyisocyanate (II) and polyol (III-I) and/or polyamine (III-II) are used in the reaction in quantities such as to provide isocyanate groups and hydroxyl and/or amino groups in molar ratio of isocyanate groups to hydroxyl and/or amino groups comprised between 2.5:1 and 1.1:1, preferably between 2.1:1 and 1.3:1.

In the case of the polyamine (III-II), said molar ratio refers to the molar ratio of isocyanate groups to primary and/or secondary amino groups of said polyamine.

In a preferred embodiment, in the preparation of the terminated (poly)urethane oligomer (I-II) polyisocyanate (II), polyol (III-I) and the monoalcohol (IV-I) are used in the reaction in quantities such as to provide isocyanate groups (II):hydroxyl groups (III):hydroxyl groups (IV) in molar ratio comprised between 2.5-1.1 (II):1 (III):0.2-2.0 (IV), more preferably between 2.0-1.3 (II):1.0 (III):0.3-1.0 (IV).

In the event in which polyisocyanate (II) is a composition comprising pre-polymerisation products, the calculation of the stoichiometric ratios between the reagents can be based, for example, on the determination of the isocyanate functions present according to the method ASTM D2572-19 or on the indications provided by the producer in the case of commercial compositions.

Preferably the molar ratios between the reagents (II), (III) and (IV) are such as to prevent, at the end of the reaction, the presence of residues of unreacted isocyanate (II).

Being oligomers, in the preparation of the terminated (poly)urethane and/or (poly)urea oligomer (I) of the invention polyisocyanate (II) and polyol (III-I) and/or polyamine (III-II) are used in the reaction in quantities such as to contribute no more than 5000 g/mol, preferably no more than 4000 g/mol, to the weight average molecular weight MW of the terminated oligomer (I).

In the preparation of the terminated (poly)urethane and/or (poly)urea oligomer (I), the reagents (II), (III) and (IV) can be added and made to react simultaneously or they can be added and made to react in order and with different modes.

For example it is possible to make polyisocyanate (II) pre-react with polyol (III-I) to give a non-terminated (poly)urethane oligomer (V-I) and then, later add the reactive alcohol (IV-I) or the monoamine (IV-II).

Analogously it is possible to make polyisocyanate (II) pre-react with polyamine (III-II) to give a non-terminated (poly)urea oligomer (V-II) and then, later add the reactive alcohol (IV-I) or the monoamine (IV-II).

Preferably the present process is carried out without isolating the non-terminated intermediate (poly)urethane or (poly)urea oligomer (V) (one-pot reaction).

Alternatively, the reactive alcohol (IV-I) or the monoamine (IV-II) can be made to pre-react with polyisocyanate (II) and subsequently the mixture can be made to react with polyol or polyamine (III).

The preparation of the terminated oligomer (I) of the invention can occur in solvent or in bulk.

In the reaction carried out in solvent, in order to improve the reaction selectivity of the polyisocyanate (II), preferably one proceeds by first providing the polyol (III-I) and/or polyamine (III-II), thus forming a non-terminated (poly)urethane or (poly)urea oligomer (V) and only at a later time one proceeds with the termination by adding monoalcohol (IV-I) or monoamine (IV-II).

Preferably the solvent is selected from aprotic polar solvents, more preferably selected from ethyl carbonate, DMSO, DMF, NMP and cyrene, preferably it is cyrene.

In a preferred embodiment, the present terminated oligomer (I) can be prepared in the absence of solvent (in bulk) since the reagents (II), (III) and (IV) are typically liquids or solids with low-melting-points and at least partially miscible with each other. The advantage in not using solvents lies in the possibility of directly obtaining the oligomer of interest without requiring any separation step, and generally in achieving improved industrial efficiency.

The process for preparing the terminated oligomer (I) of the present invention can be carried out in the presence of conventional catalysts commonly used for the synthesis of polyurethanes, such as metal-organic compounds, tertiary amines and the like such as for instance DIPRANE™ LC 1021 by DOW.

The process can be carried out in the presence of a water adsorbent, in order to prevent the loss of isocyanate via hydrolysis, such as for example zeolite.

Advantageously the present process can be carried out in suitable dedicated plants rather than in the conventional rubber mixers, as shown for example in the document Materials (2018), 11, 2175 previously commented on, thus preventing possible safety problems for the field operators.

In the event in which the final product comprises, in addition to the desired terminated (poly)urethane and/or (poly)urea oligomer (I), unreacted isocyanate groups of the polyisocyanate (II), said final product is preferably subjected to treatments for removing such unreacted isocyanate groups, such as washings with suitable solvents or thermal treatments.

Preferably in order to remove the unreacted isocyanate (II) said final product is subjected to thermal treatment. Preferably said thermal treatment comprises heating in an oven the final product at temperatures comprised between 100 and 150° C., for a time approximately from 1 to 48 hours, possibly under vacuum at a pressure for example from 10⁻⁵ to 10⁻³ Pascal.

The possible presence of unreacted isocyanate (II) in the final product and its removal via heating, can be easily evaluated by for example IR spectroscopy.

Analogous to that described above for the terminated (poly)urethane oligomers (I), one can proceed in the preparation of terminated (poly)urea oligomers of formula (I) by using polyamines (III-II) rather than polyols and terminating the (poly)urea oligomer by reaction with monoamines (IV-II) or monoalcohols (IV-I).

In the preparation of the present terminated oligomers (I), additives can be used such as stabilising agents, colorant or other additives commonly used in the field.

A further aspect of the present invention is represented by a composition for an elastomeric tyre compound comprising at least
100 phr of at least one diene polymer,
at least 1 phr of at least one terminated (poly)urethane and/or (poly)urea oligomer (I) as defined above; and
at least 0.1 phr of a vulcanising agent.

With the term “composition for an elastomeric tyre compound” a composition, comprising at least one diene polymer and one or more additives, which by mixing and possible heating supplies an elastomeric compound suitable for use in tyres and their components is meant.

The components of the composition for elastomeric compound are not generally introduced in the mixer simultaneously but typically are sequentially added. In particular, the vulcanisation additives, such as the vulcanising agent and possibly the accelerants and the retardants, are usually added in a step downstream of the incorporation and processing of all the other components.

In the vulcanisable elastomeric compound, the single components of the composition for elastomeric compound can be altered or no longer individually traceable since modified, completely or in part, due to the interaction with the other components, the heat and/or the mechanical processing. With the term “composition for elastomeric compound”, it is herein intended to include the set of all the components that are used in the preparation of the elastomeric compound, independent of whether these are actually simultaneously present, whether they are introduced sequentially or if they are then traceable in the elastomeric compound or in the final tyre.

With the term “diene polymer” an elastomeric polymer derived from the polymerisation of one or more monomers, including at least one conjugated diene is meant.

With the term “reinforcing filler” or filler, an agent which, when incorporated in the elastomeric compound, is capable of improving the dynamic and static mechanical properties of the vulcanised elastomeric compound is meant.

The composition for an elastomeric tyre compound according to the present invention is characterised by one or more of the following preferred aspects taken separately or in combination with each other.

The composition for elastomeric compound according to the invention comprises 100 phr of at least one diene polymer.

The composition for elastomeric compound according to the invention can comprise two or more diene polymers in mixture for a total of 100 phr.

The diene polymer can be selected from among those commonly used in compositions vulcanisable with sulphur, which are particularly suitable for producing tyres, i.e. from solid elastomeric polymers or copolymers with an unsaturated chain having a glass transition temperature (Tg) generally lower than 20° C., preferably comprised in the interval from 0°° C. to −110° C.

These polymers or copolymers can be of natural origin or they can be obtained by means of polymerisation in solution, polymerisation in emulsion or polymerisation in gaseous phase of one or more conjugated dienes, possibly mixed with at least one co-monomer selected from monoolefins, monovinylarenes and/or polar co-monomers in a quantity non greater than 60% by weight.

The conjugated dienes generally comprise from 4 to 12, preferably from 4 to 8 carbon atoms and can be selected for example from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene and mixtures thereof. 1,3-butadiene and isoprene are particularly preferred.

The monoolefins can be selected from ethylene and a-olefin generally containing from 3 to 12 carbon atoms, such as, for example, propylene, 1-butene, 1-pentene, 1-hexene, 1-octene or mixtures thereof.

Monovinylarenes, which can be possibly used as comonomers, generally contain from 8 to 20, preferably from 8 to 12 carbon atoms and can be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-metilstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, and mixtures thereof.

Styrene is particularly preferred.

Polar co-monomers that may possibly be used can be selected for example from: vinylpyridine, vinylquinoline, acrylic acid and alkylacrylic acid esters, acrylonitriles, or mixtures thereof, such as for example methyl acrylate, ethyl acrylate, methyl methacrylate, ethyl methacrylate, acrylonitrile and mixtures thereof.

Preferably, the diene polymer can for example be selected from cis-1,4-polyisoprene (natural or synthetic, preferably natural rubber), 3,4-polyisoprene, polybutadiene (in particular polybutadiene with a high content of 1,4-cis), possibly halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, and mixtures thereof. The composition for elastomeric compound can possibly comprise at least one polymer of one or more monoolefins with a olefin comonomer or derivates thereof. The monoolefins can be selected from: ethylene and a-olefin generally containing from 3 to 12 carbon atoms, such as for example propylene, 1-butene, 1-pentene, 1-hexene, 1-octene or mixtures thereof. The following are preferred: copolymers between ethylene and an α-olefin, possibly with a diene; homo-polymers of isobutene or their copolymers with small quantities of a diene, which are possibly at least partly halogenated. The diene possibly present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; and mixtures thereof.

The composition for an elastomeric tyre compound of the invention comprises at least 1 phr of a terminated (poly)urethane and/or (poly)urea oligomer (I).

Preferably the present composition comprises at least 2 phr or at least 3 phr, more preferably at least 5 phr or at least 8 phr of at least one terminated (poly)urethane and/or (poly)urea oligomer (I).

The composition for tyre compounds of the invention preferably comprises not more than 100 phr, more preferably not more than 70 phr, still more preferably not more than 30 phr of at least one terminated (poly)urethane and/or (poly)urea oligomer (I).

The composition for tyre compounds of the invention preferably comprises from 2 phr to 70 phr, more preferably from 3 phr to 30 phr, still more preferably from 5 phr to 20 phr of at least one terminated (poly)urethane and/or (poly)urea oligomer (I).

The composition for tyre compounds of the invention can comprise two or more of said oligomers of formula (I) in mixture, preferably in a total quantity in accordance with the above-expressed preferences.

The elastomeric tyre composition according to the present invention can comprise at least one reinforcing filler.

The present composition can comprise two or more reinforcing fillers in mixture.

The present composition can comprise at least 1.5 phr, 2 phr, 5 phr or at least 10 phr of at least one reinforcing filler or mixtures thereof.

The present composition can comprise from 1 phr to 150 phr, from 1 phr to 120 phr, from 5 phr to 120 phr or from 10 phr to 90 phr of at least one reinforcing filler or mixtures thereof.

Preferably, the reinforcing filler is selected from carbon black, silica, silicates, lamellar or fibrous, gypsum, talc, kaolin, bentonite, titanium dioxide, possibly modified, or mixtures thereof, preferably selected from carbon black, silica, silicates or mixtures thereof.

In one embodiment, said reinforcing filler comprises carbon black.

Preferably, the carbon black is selected from those having a surface area not lower than 20 m²/g, preferably greater than 50 m²/g (determined by STSA—statistical thickness surface area according to ISO 18852:2005).

The carbon black can for example be N234, N326, N330, N375 or N550, N660 sold by Birla Group (India) or by Cabot Corporation.

In one embodiment, said reinforcing filler comprises modified carbon black.

Carbon black can for example be modified by reaction with modifying reagents such as serinolpyrrole, as described for example in WO2016050887A1 or by oxidation (oxidized carbon black) as shown in the application PCT/IB2019/060596.

In one embodiment, said reinforcing filler comprises a conventional silica, such as the silica from sand precipitated with strong acids, preferably amorphous, or a silica from rice hull as described for example in WO2019229692A1.

Commercial examples of suitable silica are Zeosil 1165 MP, Zeosil 1115 MP, Zeosil 185 GR, Efficium by Solvay, Newsil HD90 and Newsil HD200 by Wuxi, K160 and K195 by Wilmar, H160AT and H180 AT by IQE, Zeopol 8755 and 8745 by Huber, Perkasil TF100 by Grace, Hi-Sil EZ 120 G, EZ 160G, EZ 200G by PPG, Ultrasil 7000 GR and Ultrasil 9100 GR by Evonik.

In one embodiment, said reinforcing filler comprises silica in mixture with carbon black.

In one embodiment, said reinforcing filler comprises modified silica.

The silica can for example be modified by reaction with silsesquioxanes (as in WO2018078480A1), by reaction with pyrroles (as in WO2016050887A1) or by reaction with silanising agents, such as bis(triethoxysilylpropyl)tetrsulphide (TESPT), 3-aminopropyltriethoxysilane (APTES) 3-glycidyloxypropyltriethoxysilane triethoxy(octyl)silane, triethoxy(ethyl)silane, triethoxy-3-(2-imidazolin-1-yl)propylsilane, triethoxy-p-tolylsilane, triethoxy(1-phenylethenyl)silane, triethoxy-2-thienylsilane, 1H,1H,2H,2H-perfluorooctyltriethoxysilane, 3-(triethoxysilyl)propyl isocyanate, 1H,1H,2H,2H-perfluorodecyltriethoxysilane, isobutyltriethoxysilane, n-octadecyltriethoxysilane, (3-chloropropyl)triethoxysilane, triethoxysilane and 3-(triethoxysilyl)propionitrile.

Commercial examples of suitable silanising agents are Si69, Dynasylan AMEO and Dynasylan GLYEO by Evonik.

The modified silica can be a sulphur-based silanised silica.

The sulphur-based silanised silica is a silica prepared by reaction of a silica, such as pyrogenic silica, precipitated amorphous silica, moist silica (hydrated silicic acid), anhydrous silica (anhydrous silicic acid), or mixtures thereof, or of a metallic silicate, such as aluminium silicate, sodium silicate, potassium silicate, lithium silicate or mixtures thereof, with at least one sulphur-based silanising agent.

With the term “sulphur-based silanising agent” an organic derivative of silicon containing mercapto, sulphide, disulphide or polysulphide groups is meant, said derivative being capable of reacting with the OH groups of silica.

A commercial example of suitable sulphur-based silanised silica is the silica Agilon 400 by PPG.

In one embodiment, said reinforcing filler comprises a modified silica in mixture with carbon black.

In one embodiment, said reinforcing filler comprises silicates.

In one embodiment, said silicates are silicate fibres. These fibres typically have nanometric dimensions and have needle-shaped morphology.

The silicate fibres are preferably selected from sepiolite fibres, palygorskite fibres (also known as attapulgite), wollastonite fibres, imogolite fibres and mixtures thereof.

In one embodiment, said reinforcing filler comprises silicate fibres in mixture with carbon black.

In one embodiment, said silicate fibres are modified silicate fibres.

In one embodiment, the modified silicate fibres can be for example fibres modified via acid treatment with partial removal of magnesium, such as those described and exemplified in the patent application WO2016/174629A1.

In one embodiment, the modified silicate fibres can be for example fibres modified by deposition of amorphous silica on the surface, like those described and exemplified in the patent application WO2016/174628A1.

In one embodiment, the modified silicate fibres can be fibres organically modified by reaction for example with quaternary ammonium salts such as the sepiolite fibres modified by reaction with talloyl benzyl dimethyl ammonium chloride sold by Tolsa with the name Pangel B5.

In one embodiment, the modified silicate fibres can be fibres modified by reaction with a silanising agent for example selected from mono or bifunctional silanes with one or two or three hydrolysable groups such as bis-(3-triethoxysilyl-propyl) disulphide (TESPD), bis(3-triethoxysilyl-propyl) tetrsulphide (TESPT), 3-thio-octanoyl-1-propyl-triethoxysilane (NXT), Me₂Si(OEt)₂, Me₂PhSiCl, Ph₂SiCl₂.

In one embodiment, said reinforcing filler comprises modified silicate fibres in mixture with carbon black.

In one embodiment, said silicates are lamellar silicates, such as bentonites, halloysite, laponite, saponite, vermiculite or hydrotalcite.

In one embodiment, said silicates are modified lamellar silicates analogous to that already described for the modified silicate fibres.

Preferably, the elastomeric composition of the invention only comprises one or more oligomers of the invention as reinforcing filler, with considerable reduction of the weight of the corresponding elastomeric compound.

The composition for tyre compounds according to the invention comprises at least one vulcanising agent.

With the term “vulcanising agent” an agent capable of transforming the natural or synthetic rubber into elastic and resistant material, due to the formation of three-dimensional crosslinking of inter- and intra-molecular bonds is meant.

Preferably, the composition comprises at least 0.2 phr, at least 0.5 phr, at least 0.8 phr or at least 1 phr of at least one vulcanising agent.

Preferably, the composition comprises from 0.1 to 10 phr, from 0.2 to 10 phr, from 1 to 10 phr or from 1.5 to 5 phr of at least one vulcanising agent.

The at least one vulcanising agent is preferably selected from sulphur, or alternatively, molecules containing sulphur (sulphur donors), such as for example, bis[(trialkoxysilyl)propyl] polysulphides, the thiurams, the dithiomorpholines and the caprolactam-disulphide and mixtures thereof.

In one embodiment, the vulcanising agent is a peroxide.

In one embodiment, the vulcanising agent is selected from the polytetrazole crosslinking agents described in the patent application WO2021/137143A1 on behalf of the Applicant.

Preferably the vulcanising agent is sulphur, preferably selected from soluble sulphur (crystalline sulphur), insoluble sulphur (polymeric sulphur) and sulphur dispersed in oil and mixtures thereof.

A commercial example of a vulcanising agent suitable for use in the composition of the invention is the sulphur Redball Superfine by International Sulphur Inc.

In the present composition the vulcanising agent can be used together with adjuvants such as vulcanisation activators, accelerants and/or retardants known to those skilled in the art.

The composition according to the invention can possibly comprise at least one agent activating the vulcanisation.

With the term “activating the vulcanisation” an agent capable of further facilitating the vulcanisation, making it occur in lower times and possible lower temperatures is meant.

The agents activating the vulcanisation suitable for use in the present composition are derivatives of zinc, in particular ZnO, ZnCO₃, zinc salts of fatty acids, saturated or unsaturated, containing from 8 to 18 carbon atoms, which are preferably formed in situ in the composition by reaction of the ZnO and of the fatty acid, like Bi₂O₃ or mixtures thereof. For example, zinc stearate is used, preferably formed in situ, in the composition, from ZnO and fatty acid, or magnesium stearate, formed by MgO, or mixtures thereof.

The agents activating the vulcanisation can be present in the composition of the invention in quantities preferably from 0.2 phr to 15 phr, more preferably from 1 phr to 5 phr.

Preferred activating agents derive from the reaction of zinc oxide and stearic acid.

An example of activator is the product Aktiplast ST sold by Rheinchemie.

The composition according to the invention can further comprise at least one vulcanisation accelerant.

With the term “vulcanisation accelerant” an agent capable of decreasing the duration of the vulcanisation process and/or the operating temperature, such as for example TBBS, sulfenamides in general, thiazoles, dithiophosphates, dithiocarbamates, guanidines, thioureas, sulfenimides, thiurams, amines, xanthates, or mixtures thereof is meant.

Preferably the accelerant agent is selected from mercaptobenzothiazole (MBT), N-cyclohexyl-2-benzothiazol-sulfenamide (CBS), N-tert-butyl-2-benothiazol-sulfenamide (TBBS) and mixtures thereof.

Commercial examples of accelerant agents suitable in the present composition are N-cyclohexyl-2-benzothiazyl-sulfenamide Vulkacit® (CBS or CZ) and N-terbutyl 2-benzothiazyl sulfenamide, Vulkacit® NZ/EGC sold by Lanxess.

Vulcanisation accelerants can be used in the present composition in a quantity preferably from 0.05 phr to 10 phr, preferably from 0.1 phr to 7 phr, more preferably from 0.5 phr to 5 phr.

The composition according to the invention can possibly comprise at least one agent vulcanisation retardant.

With the term “vulcanisation retardant” an agent capable of delaying the onset of the vulcanisation reaction and/or suppressing undesired secondary reactions, for example N-(cyclohexylthio) phthalimide (CTP), urea, phthalic anhydride, N-nitrosodiphenylamine, N-cyclohexylthiophthalimide (CTP or PVI) and mixtures thereof is meant.

A commercial example of suitable retardant agent is N-cyclohexylthiophthalimide VULKALENT G by Lanxess.

The vulcanisation retardant agent can be present in the present composition in a quantity preferably from 0.05 phr to 2 phr.

The present composition can comprise one or more vulcanisation retardant agents, as defined above in mixture.

With the term “vulcanisation package” the set of the vulcanising agent and one or more vulcanisation additives selected from vulcanisation activators, accelerants and retardants is meant.

The composition according to the invention can possibly comprise at least 0.5 phr, more preferably at least 1 phr or 2 phr of at least one silane coupling agent.

Preferably, the composition according to the invention comprises from 0.5 phr to 20.0 phr or from 0.5 phr to 10.0 phr, still more preferably from 1.0 phr to 5.0 phr of at least one silane coupling agent.

Preferably, said coupling agent is a silane coupling agent selected from those having at least one hydrolysable silane group, which can be identified, for example, by the following general formula (VI):

(R′)₃Si—C_{q}H_{2q}—Q (VI)
wherein the groups R′, equal to or different from each other, are selected from: alkyl, alkoxy or aryloxy groups, or from halogen atoms, provided that at least one of the groups R′ is an alkoxy or aryloxy group; q is an integer from 1 to 6; Q is a group selected from: nitrous, mercapto, amino, epoxy, vinyl, imide, chloro, —(S)ₘC_{q}H_{2q}—Si—(R′)₃ and —S—COR′, wherein m and q are integers from 1 to 6 and the groups R′ are defined as above.

Silane coupling agents that are particularly preferred are bis(3-triethoxy-silyl-propyl) tetrsulphide and bis(3-triethoxysilyl-propyl) disulphide, also termed polysulphide compatilising agents. Said coupling agents can be admixed as such or in mixture with an inert filler (for example carbon black) so as to facilitate their incorporation in the composition.

One example of a silane coupling agent is TESPT: bis (3-triethoxysilpropyl) tetrsulphide Si69 sold by Evonik.

The composition according to the invention can further comprise one or more additional ingredients, commonly used in the field, such as for example plasticising oils, resins, antioxidant agent and/or antiozonants (anti-aging agents), waxes, adhesives and the like.

For example, the composition according to the present invention for the purpose of further improving the processability of the compound, can further comprise at least one plasticising oil.

The quantity of plasticiser is preferably from 1 phr to 80 phr, preferably from 10 phr to 70 phr, more preferably from 30 phr to 50 phr.

With the term “plasticising oil” a process oil derived from petroleum or a mineral oil or an oil of plant origin or an oil of synthetic origin or their combinations is meant.

The plasticising oil can be a process oil derived from petroleum selected from paraffins (saturated hydrocarbons), naphthenes, aromatic polycycles and mixtures thereof.

Examples of suitable process oils derived from petroleum are aromatic oils, paraffins, naphthenes such as MES (Mild Extract Solvated), DAE (Distillate Aromatic Extract), TDAE (Treated Distillate Aromatic Extract), TRAE (Treated Residual Aromatic Extract), RAE (Residual Aromatic Extract) known in the field.

The plasticising oil can be an oil of natural or synthetic origin derived from the esterification of glycerol with fatty acids, comprising triglycerides, diglycerides, monoglycerides of glycerol or mixtures thereof.

Examples of suitable plant oils are sunflower oil, soy oil, linseed oil, rapeseed oil, castor oil and cotton oil.

The plasticising oil can be a synthetic oil selected from alkyl or aryl esters of phthalic acid or phosphoric acid.

The composition according to the present invention can further comprises at least one resin.

The resin, if used in the composition, is a non-reactive resin, preferably selected from the group that comprises hydrocarbon resins, phenolic resins, natural resins and mixtures thereof.

The quantity of resin can range from 0 phr to 80 phr, preferably from 10 phr to 40 phr.

The composition according to the invention can possibly comprise at least one wax. The wax can for example be a petroleum wax or a mixture of paraffins.

Commercial examples of suitable waxes are the mixture of N-paraffins of Repsol and the microcrystalline wax Antilux® 654 by Rhein Chemie.

The wax can be present in the composition of the invention in an overall quantity generally ranging from 0.1 phr to 20 phr, preferably from 0.5 phr to 10 phr, more preferably from 1 phr to 5 phr.

The composition according to the invention can possibly comprise at least one antioxidant agent.

The antioxidant agent is preferably selected from N-isopropyl-N′-phenyl-p-phenylenediamine (IPPD), N-(1, 3-dimethyl-butyl)-N′-phenyl-p-phenylenediamine (6PPD), N,N′-bis-(1, 4-dimethyl-pentyl)-p-phenylenediamine (77PD), N,N′-bis-(1-ethyl-3-methylpentyl)-p-phenylene-diamine (DOPD), N,N′-Bis-(1, 4-dimethylpentyl)-p-phenylenediamine, N,N′-diphenyl-p-phenylenediamine (DPPD), N,N′-ditolyl-p-phenylenediamine (DTPD), N,N′-di-beta-naphthyl-p-phenylenediamine (DNPD), N,N′-Bis(1-methylheptyl)-p-phenylenediamine, N,N′-Di-sec-butyl-p-phenylenediamine (44PD), N-phenyl-N′-cyclohexyl-p-phenylenediamine, N-phenyl-N′-1-methylheptyl-p-phenylenediamine and the like, and mixtures thereof, preferably it is N-1,3-dimethyllbutyl-N-phenyl-p-phenylendiamine (6-PPD).

A commercial example of a suitable antioxidant agent is Santoflex 6PPD by Eastman.

The antioxidant agent can be present in the composition in an overall quantity preferably from 0.1 phr to 20 phr, preferably from 0.5 phr to 10 phr.

A further aspect of the present invention is represented by an elastomeric tyre compound obtained by mixing and vulcanising the composition according to the invention.

With the term “elastomeric compound” the mixture obtainable by mixing and possible heating of at least one diene polymer with at least one of the additives commonly used in the preparation of tyre compounds is meant.

With the term “elastomeric polymer” a natural or synthetic polymer which, after vulcanisation, can be repeatedly stretched at room temperature to at least twice its original length and after removal of the tensile load substantially immediately returns, and with force, to its approximately original length (according to the definitions of the norm ASTM D1566-11 Standard terminology relating to Rubber) is meant.

With the term “vulcanisation” the crosslinking reaction in a natural or synthetic rubber, induced for example by a vulcanising agent with sulphur base is meant.

With the term “green” a material, a compound, a composition, a component or a tyre not yet vulcanised is meant.

The elastomeric compound according to the invention, when vulcanised, has dynamic properties that are improved and static properties that are comparable with respect to analogous compounds comprising only conventional reinforcing fillers, as shown in the present experimental part.

Due to the lower density of the filler constituted by the oligomer of formula (I) according to the invention, the present elastomeric compounds have a considerable reduction of weight with respect to the corresponding compounds comprising conventional fillers.

The present elastomeric compound can be prepared according to a process which typically comprises one or more steps of mixing in at least one suitable mixer, in particular at least one mixing step 1 (not productive) and one mixing step 2 (productive).

With the term “mixing step (1)”, the step of the process of preparation of the elastomeric compound in which by mixing and possibly heating, one or more additives can be incorporated, except for the vulcanising agent that is fed in step (2) is meant. The mixing step (1) is also termed “non-productive step”. In the preparation of a compound there can be multiple “non-productive” mixing steps that can be indicated with 1a, 1b, etc.

With the term “mixing step (2)”, the next step of the process of preparation of the elastomeric compound in which the vulcanising agent and, possibly, the other additives of the vulcanisation package are introduced in the elastomeric compound obtained from step (1), and mixed in the material, at controlled temperature, generally at a compound temperature lower than 120° C., so as to supply the vulcanisable elastomeric compound is meant. The mixing step (2) is also termed “production step”.

Each step of mixing can comprise multiple intermediate steps or sub-steps of the processing, characterised by the momentary interruption of the mixing in order to allow the addition of one or more ingredients but without intermediate unloading of the compound.

The mixing can for example be carried out by using an open mixer of “open-mill” type or internal mixer of the type with tangential rotors (Banbury®) or with penetrating rotors (Intermix), or in continuous mixers of Ko-Kneader™ (Buss®) type or of the type with twin screws or multiscrew type.

For this purpose, after one or more thermomechanical treatment stages (step 1), where typically the rubber is processed with several of the additives such as the reinforcing fillers, the activators, the antioxidants and, preferably, the terminated oligomers (I), the vulcanising agent, together with vulcanisation accelerants and/or retardants are incorporated in the materials. In the final treatment step (production step 2), the temperature is generally maintained lower than 120° C. and preferably lower than 100° C., so as to prevent any undesired phenomenon of pre-vulcanisation. Subsequently, the compound is incorporated in one or more components of the tyre and subjected to vulcanisation, according to known techniques.

A further aspect of the present invention is represented by a tyre component for vehicle wheels comprising, or preferably constituted by the elastomeric compound according to the invention.

The tyre component can be selected from any tyre component such as tread band, under-layer, anti-abrasive layer, sidewall, sidewall insert, mini-sidewall, liner, under-liner, rubber layers, bead filler, bead reinforcing layers (flippers), bead protection layers (chafers), sheet, preferably between tread band and rubber layers.

A further aspect of the present invention is represented by a tyre for vehicle wheels comprising at least one tyre component according to the invention.

Preferably the tyre according to the invention comprises the present elastomeric compound in more than one component, so as to more greatly reduce the weight of the tyre, preferably at least in the tread band and in the rubber layers.

In one embodiment, the tyre according to the invention comprises at least:
a carcass structure comprising at least one carcass layer having opposite lateral edges associated with respective bead structures;
possibly a pair of sidewalls respectively applied on the lateral surfaces of the carcass structure in axially outer position;
possibly a belt structure applied in radially outer position to the carcass structure;
a tread band applied in radially outer position to said carcass structure or, if present, belt structure,
possibly a layer of elastomeric material, said under-layer, applied in a radially inner position with respect to said tread band,
wherein at least one component, preferably at least the tread band, comprises or preferably consists of the elastomeric compound according to the invention.

Due to the reduction of the weight and of the hysteresis of the elastomeric compound that incorporates the present terminated oligomer (I) as reinforcing filler, it is particularly advantageous to use such compound in making the tread band of the tyre.

The tyre according to the invention can be a tyre for vehicles with two, three or four wheels and can be for summer or winter use, or all-season.

In one embodiment, the tyre according to the invention is a tyre for motorcycle wheels wherein at least one component comprises or preferably consists of the elastomeric compound according to the invention. Typically a tyre for motorcycle wheels is a tyre that has a right section marked by a high transverse curvature. In a preferred embodiment, the tyre according to the invention is a tyre for sport or competition motorcycle wheels.

In one embodiment, the tyre according to the invention is a tyre for car wheels.

In one embodiment, the tyre according to the invention is a tyre for high-performance cars (HP, SUV and UHP) wherein at least one component comprises or preferably consists of the elastomeric compound according to the invention.

In one embodiment, the tyre according to the invention is a tyre for bicycle wheels.

A tyre for bicycle wheels comprises typically a carcass structure turned up around a pair of bead cores at the beads and a tread band placed in radially outer position with respect to the carcass structure.

The tyre according to the present invention can be produced according to a process which comprises:
forming components of a green tyre on at least one building drum;
shaping, moulding and vulcanising the tyre;
wherein forming at least one of the green tyre components comprises:
manufacturing at least one green component comprising, or preferably consisting of, the elastomeric compound according to the invention.

In the event in which the tyre comprises a compound containing the terminated (poly)urethane and/or (poly)urea oligomer (I), wherein X comprises a reactive group capable of covalently binding to the diene polymers, advantageously the oligomer (I) dispersed in the compound can for example react during the vulcanisation and thus be anchored to the elastomeric mass.

If instead, in the terminated (poly)urethane and/or (poly)urea oligomer (I), the organic residue X comprises a hydrophobic group, advantageously the oligomer (I) will be dispersed in the elastomeric mass during the mixing steps.

### Description of a Tyre According to the Invention

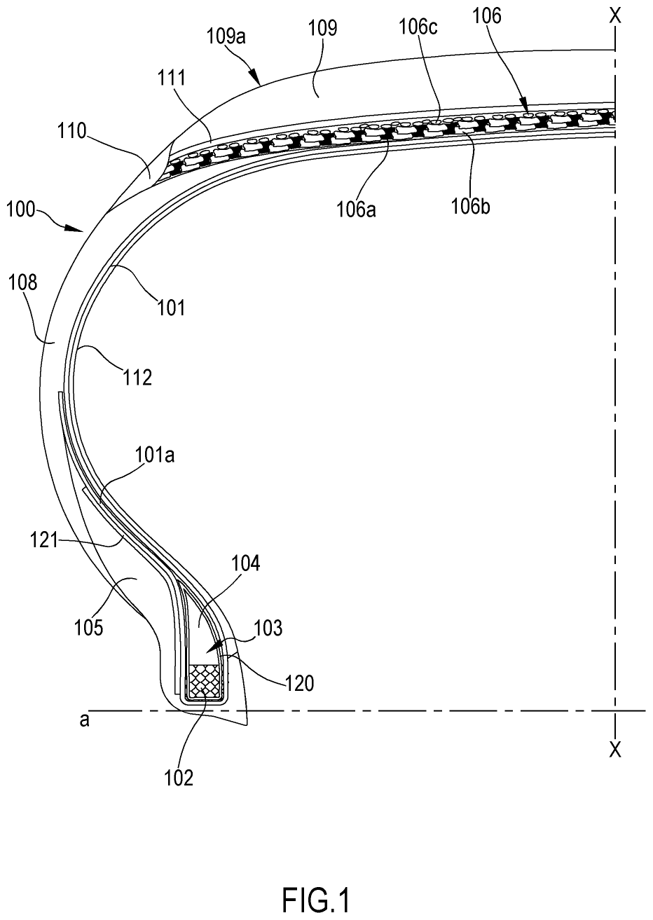

A tyre for vehicle wheels according to the invention, comprising at least one component comprising the present elastomeric compound, is illustrated in radial half-section in FIG. 1.

In FIG. 1 “a” indicates an axial direction and “X” indicates a radial direction, in particular with X—X the trace of the equatorial plane is indicated. For the sake of simplicity, FIG. 1 shows only one portion of the tyre, the remaining not-represented portion being identical and arranged symmetric with respect to the equatorial plane “X—X”.

The tyre (100) for four-wheel vehicles comprises at least one carcass structure, comprising at least one carcass layer (101) having respectively opposite end flaps engaged with respective anchoring annular structures (102), termed bead cores, possibly associated to a bead filler (104).

The zone of the tyre comprising the bead core (102) and the filler (104) forms a bead structure (103) intended for anchoring the tyre on a corresponding mounting rim, not illustrated.

The carcass structure is usually of radial type, i.e. the reinforcing elements of the at least one carcass layer (101) are situated on planes comprising the rotation axis of the tyre and substantially perpendicular to the equatorial plane of the tyre. Said reinforcing elements are generally constituted by textile cords, for example rayon, nylon, polyester (e.g. polyethyl naphthalate PEN). Each bead structure is associated with the carcass structure by folding backward of the opposite lateral edges of the at least one carcass layer (101) around the anchoring annular structure (102) so as to form the so-called up-turns of the carcass (101a) as illustrated in FIG. 1.

In one embodiment, the coupling between carcass structure and bead structure can be provided by means of a second carcass layer (not represented in FIG. 1) applied in an axially outer position with respect to the first carcass layer.

An anti-abrasive layer (105) possibly made with elastomeric material is arranged in an outer position of each bead structure (103).

Associated with the carcass structure is a belt structure (106) comprising one or more belt layers (106a), (106b) situated in radial superimposition with respect to each other and with respect to the carcass layer, having reinforcing cords that are typically textile and/or metallic incorporated within a layer of elastomeric material.

Such reinforcing cords can have cross orientation with respect to a circumferential extension direction of the tyre (100). By “circumferential” direction a direction generically directed according to the rotation direction of the tyre is meant.

In radially more external position with respect to the belt layers (106a), (106b), at least one zero degree reinforcing layer (106c), commonly known as “0° belt”, can be applied, which generally incorporates a plurality of elongated reinforcing elements, typically metallic or textile cords, oriented in a substantially circumferential direction, thus forming an angle of a few degrees (e.g. an angle between about 0° and 6°) with respect to a direction parallel to the equatorial plane of the tyre, and covered with an elastomeric material.

A tread band (109) comprising the elastomeric compound according to the invention is applied in a position radially outer to the belt structure (106). Respective sidewalls (108) made of elastomeric material are also applied in axially outer position on the lateral surfaces of the carcass structure, each extended from one of the lateral edges of the tread (109) up to the respective bead structure (103).

In radially outer position, the tread band (109) has a rolling surface (109a) intended to come into contact with the ground. Circumferential grooves, which are connected by transverse grooves (not represented in FIG. 1) so as to define a plurality of blocks of various shape and size distributed on the rolling surface (109a), are generally made in this surface (109a), which for the sake of simplicity in FIG. 1 is represented smooth.

An under-layer (111) made of elastomeric material can be arranged between the belt structure (106) and the tread band (109).

A strip constituted by elastomeric material (110), commonly known as “mini-sidewall”, may possibly be present in the zone of connection between the sidewalls (108) and the tread band (109), this mini-sidewall being generally obtained by co-extrusion with the tread band (109) and allowing an improvement of the mechanical interaction between the tread band (109) and the sidewalls (108). Preferably the end portion of the sidewall (108) directly covers the lateral edge of the tread band (109).

In the case of tyres without air chamber, a rubber layer (112), generally known as “liner”, which provides the necessary impermeability to the tyre inflation air, can also be provided in a radially inner position with respect to the carcass layer (101).

The rigidity of the sidewall of the tyre (108) can be improved by providing the bead structure (103) with a reinforcing layer (120) generally known as “flipper” or additional striplike insert.

The flipper (120) is a reinforcing layer which is wound around the respective bead core (102) and the bead filler (104) so as to at least partially surround them, said reinforcing layer being arranged between the at least one carcass layer (101) and the bead structure (103). Usually, the flipper is in contact with said at least one carcass layer (101) and said bead structure (103).

The flipper (120) typically comprises a plurality of textile cords incorporated within a layer of elastomeric material.

The reinforcing annular structure or bead (103) of a tyre can comprise a further protection layer which is generally known with the term “chafer” (121) or protection strip and which has the function of increasing the rigidity and integrity of the bead structure (103).

The chafer (121) usually comprises a plurality of cords incorporated within a rubber layer made of elastomeric material. Such cords are generally made of textile materials (e.g. aramid or rayon) or of metallic materials (e.g. steel cords).

A layer or sheet of elastomeric material can be arranged between the belt structure and the carcass structure. The layer can have a uniform thickness. Alternatively, the layer can have a thickness variable in axial direction. For example, the layer can have a greater thickness close to its axially outer edges with respect to the central (crown) zone.

Advantageously the layer or sheet can be extended on a surface substantially corresponding to the extension surface of said belt structure.

In an embodiment, a layer of elastomeric material, said under-layer, can be placed between said belt structure and said tread band, said under-layer preferably being extended on a surface substantially corresponding to the extension surface of said belt structure.

The elastomeric compound according to the present invention can be advantageously incorporated in one or more of the abovementioned components of the tyre, with considerable reduction of the overall weight of the tyre with respect to compounds comprising conventional reinforcing fillers.

The building of the tyre (100) as described above, can be carried out by assembly of respective semifinished products adapted to form the components of the tyre, on a building drum, not illustrated, due to at least one assembly device.

At least one part of the components intended to form the carcass structure of the tyre can be built and/or assembled on the building drum. More particularly, the building drum is first adapted to receive the possible liner, and subsequently the carcass structure. Subsequently, non-illustrated devices coaxially engage, around each of the end flaps, one of the anchoring annular structures, they position an external sleeve comprising the belt structure and the tread band in coaxially centred position around the cylindrical carcass sleeve and shape the carcass sleeve according to a toroidal configuration by means of a radial expansion of the carcass structure, so as to determine the application thereof against a radially inner surface of the external sleeve.

Following the building of the green tyre, a treatment of moulding and vulcanisation is carried out, aimed at determining the structural stabilisation of the tyre by crosslinking of the elastomeric compositions as well as imparting a desired tread design on the tread band and possible distinctive graphic marks at the sidewalls.

For the purposes of the present description and of the following claims, the term “phr” (parts per hundreds of rubber) indicates the parts by weight of a given component of elastomeric compound per 100 parts by weight of the elastomeric polymer, considered net of possible plasticising extension oils.

Where not otherwise indicated, all the percentages are percentages by weight.

### Experimental Part

### Analysis Methods

Softening/melting point: 0.3 g of specimen are weighed in a 4 ml becher cylindrical container. The becher container containing the specimen was then positioned in an oil path previously preheated to 50° C. Every 20 minutes, the temperature was increased to 100, 150, 160 and 170° C. in order to observe softening phenomena or melting of the specimen.

Density: the density of the terminated oligomers (I) was measured with a helium picnometer by Micromeritics (Accupyc 1330 model), suitable for determining the density of materials in powder form or pellets.

The measurement was carried out by applying the following parameters: 40 conditioning cycles, with conditioning pressure equal to the fill pressure of 19.5 psi, number of measurements per material equal to 20, from which the mean is calculated. The precision of the measurement is at least equal to +/−0.05%, ensured by the instrument calibration procedure, carried out before each series of measurements. The time of stabilisation before starting with the analysis was about 1h.

Determination of the weight average molecular weight: the weight average molecular weight MW of the terminated oligomers (I) was determined based on the distribution of the molecular weights obtainable by GPC analysis, with an Agilent 1260 Infinity instrument equipped with a refraction index detector and two PLgel 5 μm MIXED-C columns, 7.5×300 mm by Agilent, using as mobile phase tetrahydrofuran (THF) or dimethylformamide (DMF), the latter possibly admixed up to 0.1% with LiBr, a flow comprised between 0.5 and 1 ml/min, at a temperature of about 35° C. when THF is used and about 80° C. with DMF. The columns were calibrated with standard polystyrene solutions in the case of THF or polymethylmethacrylate, if dimethylformamide was used.

### 1H-NMR

The NMR spectra were acquired with a Bruker 400 instrument. The specimens were prepared by dissolving 5-10 mg of product in about 0.6 ml of deuterated solvent (Chloroform or DMSO)

### IR

The IR spectra were acquired with a Perkin-Elmer spectrum 100 (FT-IR) instrument. The specimen was directly loaded on the crystal and pressed with a metallic tip. The spectrum was recorded in ATR (Attenuate Total Reflectance) mode.

### Rheological Properties of the Elastomeric Compounds (RPA)

The rheological properties were evaluated by using a Monsanto R.P.A. 2000 rheometer according to the following method: cylindrical test specimens were prepared with weight from 4.5 g to 5.5 g by punching the elastomeric compounds.

The specimens of the compounds were subjected to heating in the rheometer at 170° C. for 10′.

The tests were carried out at an oscillation frequency of 1.66 Hz (100 oscillations per minute) and an oscillation amplitude of ±0.5°.

The values of MH, ML, MH-ML, T90, S′ measured for the elastomeric reference compounds 13A and according to the invention 13B and 13C, are reported in Table 4.

### Dynamic Mechanical Properties of the Elastomeric Compounds

The specimens of the vulcanised elastomeric compounds as described above were subjected to the measurement of the dynamic elastic tensile modulus E′ and of the Tan Delta at the temperatures of 23° C. and 70° C. (frequency 100 Hz), with the results reported in Table 5.

### Static Mechanical Properties of the Elastomeric Compounds

The elastomeric materials were vulcanised to give rise to test specimens on which the evaluation of the static mechanical properties was carried out.

The tensile tests were carried out on test specimens with rectilinear axis, such as Dumbbell.

The vulcanisation was carried out in a mould, in a hydraulic press at 170° C. and at the pressure of 200 bar for a time of about 10 minutes.

The static mechanical properties were measured at 23° C. according to the standard ISO 37:2005. In particular, the load was measured at different levels of elongation (100%, 200% and 300%, respectively termed CA1, CA2 and CA3), the ratio between CA3 and CA1, the load at break CR and the elongation at break AR %.

For the scope of better illustrating the present invention, the following Examples are now provided.

In the following Table 2, the initials, the reagents and the products of Examples 1-12 are reported:

TABLE 2

| Class | Class | Initials | Product | S/B | Ex. |
|---|---|---|---|---|---|
| Reactive | IV | IV-A (EP) | Ethanoldimethylpyrrole | — | 1, 2, 4, 5 |
| alcohol | | | | | |
| Reactive | IV | IV-B (GER) | Geraniol | — | 3, 6-11, 12 |
| alcohol | | | | | |
| Isocyanate | II | II-B (IS1) | Oligomer of MDI ISO 137 | — | 2, 3 |
| Isocyanate | II | II-C (IS2) | Hexamethylene | — | 5, 6 |
| | | | diisocyanate (HDI) | | |
| Isocyanate | II | II-D (IS1) | Oligomer of MDI | — | 7, 10, 12 |
| | | | HYPERLAST ™ LE 5046 | | |
| Isocyanate | II | II-E (IS1) | Oligomer of MDI | — | 4 |
| | | | VORALAST GE143 | | |
| Diol | III | III-A (BD) | 1,4 butanediol | — | 1-11 |
| Polyol | III | III-B (GLC) | glycerol | — | 12 |
| Terminated | I | I-A | EP-IS1-BD-IS1-EP | S | 2 |
| oligomer | | | | | |
| Terminated | I | I-B | GER-IS1-BD-IS1-BD-IS1- | S | 3 |
| oligomer | | | GER | | |
| Terminated | I | I-C | EP-IS1-BD-IS1-BD-IS1-EP | S | 4 |
| oligomer | | | | | |
| Terminated | I | I-D | EP-IS2-BD-IS2-BD-IS2-EP | S | 5 |
| oligomer | | | | | |
| Terminated | I | I-E | GER-IS2-BD-IS2-BD-IS2- | S | 6 |
| oligomer | | | GER | | |
| Terminated | I | I-F | GER-IS1-BD-IS1-GER | B | 7, 8, 9 |
| oligomer | | | | | |
| Terminated | I | I-B | GER-IS1-BD-IS1-BD-IS1- | B | 10, 11 |
| oligomer | | | GER | | |
| Terminated | I | I-G | GER-IS1-(GLC-BD)-IS1- | B | 12 |
| oligomer | | | (GLC-BD)-IS1-GER | | |

in which
S/B: reaction in solvent/in bulk,
Ethanoldimethylpyrrole (IV-A) was prepared as in Example 1,
Geraniol was provided by Sigma Aldrich,
ISO 137 by BASF is a polyurethane oligomer of 4,4′-methylenediphenylisocyanate (MDI) (% NCO = 18.2%; P.M. = 462),
Hexamethylene diisocyanate (HDI) by Sigma Aldrich. (% NCO = 50%, P.M. = 168 g/mol),
HYPERLAST ™ LE 5046 by DOW is a polyurethane oligomer of 4,4′-methylenediphenylisocyanate (MDI) (% NCO = 26.26; P.M. = 320),
VORALAST GE143 by DOW is a polyurethane oligomer of MDI (% NCO = 18.2, P.M. 462),
1,4 butanediol is DIPRANE ™ C by DOW,
Glycerol was provided by Aldrich and used in partial substitution of butanediol.

In the terminated oligomers (I), EP and GER indicate the residue deriving from the Ethanoldimethylpyrrole (IV-A) alcohol or Geraniol (IV-B) respectively, IS1 and IS2 indicate the residue deriving from the 4,4′-MDI or hexamethylene isocyanate respectively, GLC and BD the residue of the glycerol and butanediol respectively. The reactions of preparation of the terminated (poly)urethane oligomers (I) of the invention of the examples from 2 to 6 were carried out in the cyrene solvent of formula (VII):

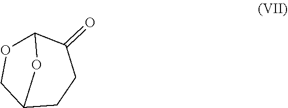

This solvent with biological origin was selected for the reactions of polymerisation, since it derives from cellulose, is non-toxic, biodegradable and is considered an effective substitute of the conventional solvents of petroleum origin, like DMF and NMP.

The reaction in the presence of solvent is typically carried out according to this scheme 1:

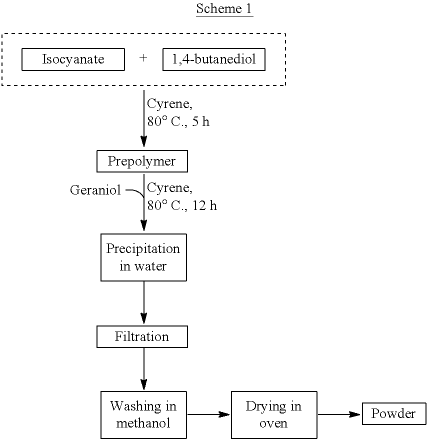

Instead, the reactions of Examples 7 to 12 were carried out in bulk, in absence of solvent, by exploiting the different reactivity of the mono-alcohol with respect to the diol, in accordance with the following scheme 2:

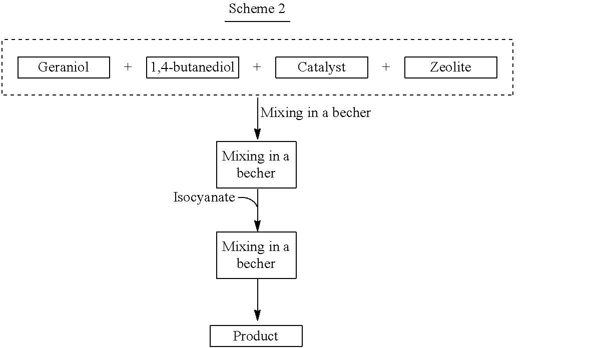

### EXAMPLE 1

### Synthesis of 2-(2,5-dimethyl-1H-pyrrol-1-yl) ethan-1-ol (EP) (IV-A)

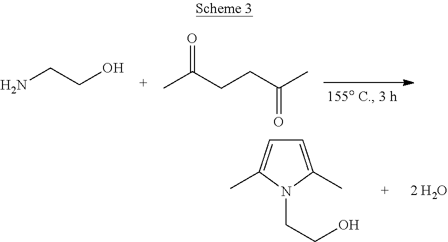

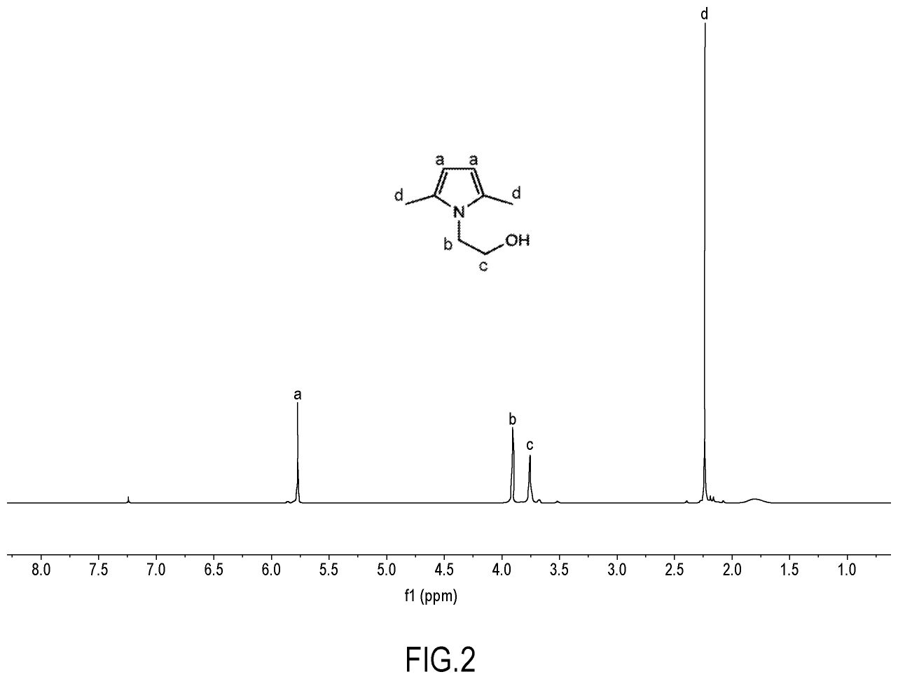

In a 100 ml flask with round bottom, provided with magnetic stirrer and condenser, ethanolamine (Sigma Aldrich, 0.071 mol, 4.33 g) was added. The temperature was then set at 155° C. and the 2,5-hexanedione (Merck, 0.071 mol, 8.35 ml) was added dropwise. After 3 hours, the reaction was stopped for cooling at ambient temperature. A brown solid was obtained, corresponding to the product 2-(2,5-dimethyl-1H-pyrrol-1-yl) ethan-1-ol (10 g, 90% yield), characterised by ¹H-NMR (400 MHz, CDCl₃) δ (ppm) 5.79 (s, 2H), 3.90 (dt, 2H), 3.75 (dd, 2H), 2.23 (s, 6H) (FIG. 2).

Synthesis of the terminated oligomers (I): formation of the pre-polymer (non-terminated oligomer) and its reaction with the reactive alcohol in solvent (one-pot)

### EXAMPLE 2 (I-A) (EP-IS1-BD-IS1-EP)

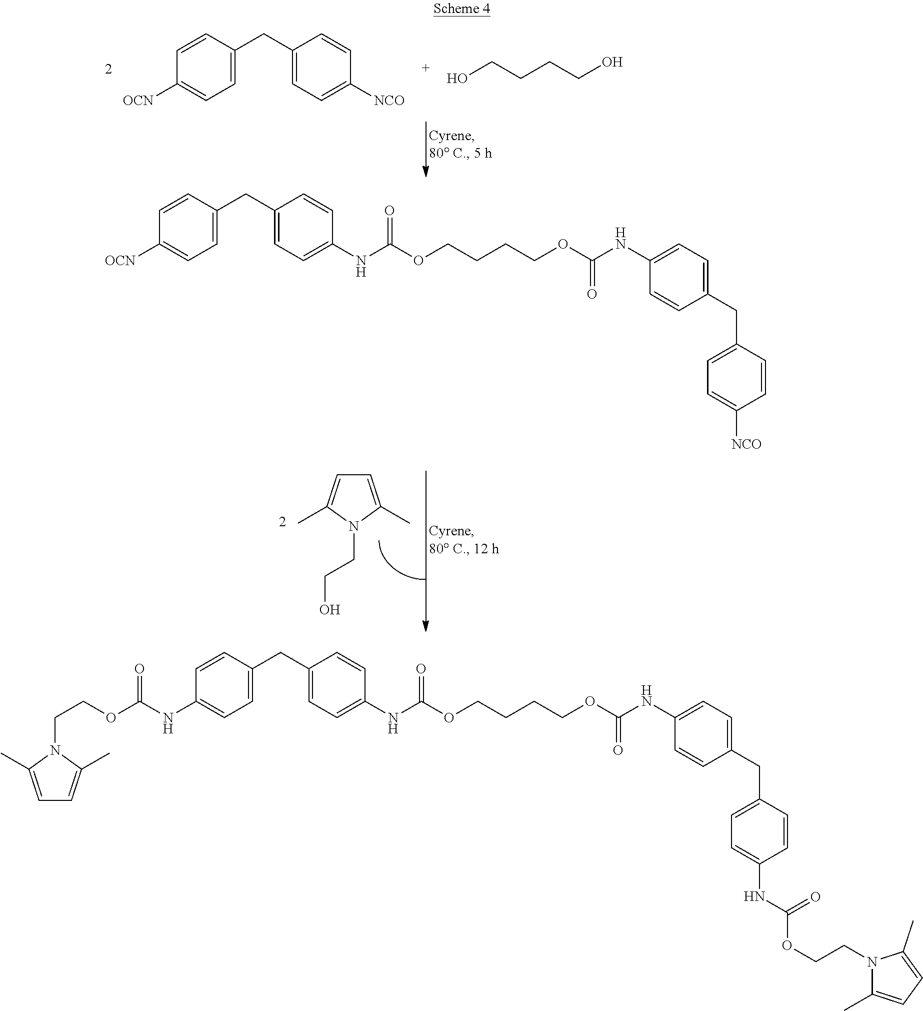

(I-A)

The terminated oligomer (I-A) was prepared according to scheme 4 reported above, in accordance with the following procedure.

In 100 ml flask with round bottom provided with magnetic stirrer isocyanate ISO 137 (II-B) (10 g, 0.022 mol, represented in the scheme for the sake of simplicity, for illustration purposes, like 4,4′-MDI pure monomer) in 25 ml of cyrene and 1,4-butanediol (Sigma Aldrich, III-A) (0.9763 g, 0.011 mol) in 4 ml of cyrene were added. After 5 hours at 80° C., the reactive alcohol EP (IV-A) (3.01 g, 0.022 mol) was added dropwise in 6 ml of cyrene. The molar ratio isocyanate groups:OH groups brought by the diol:OH groups brought by the reactive alcohol was 2:1:1. The reaction was left under stirring for 12 hours at 80° C.

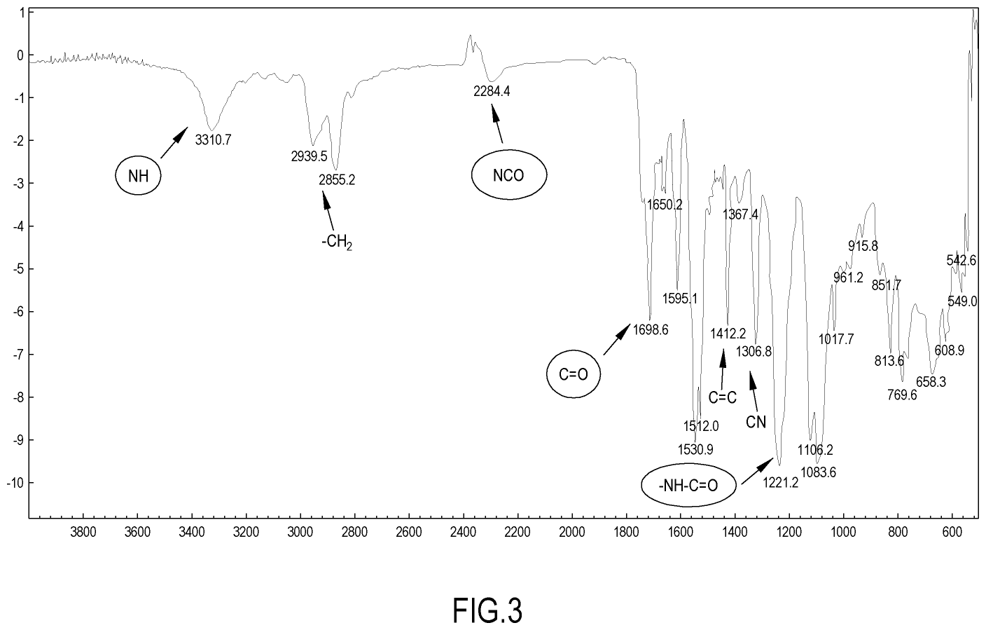

After this time, the product was precipitated in water, filtered under vacuum on Buchner and newly washed with acetone in order to remove the unreacted ethanolpyrrol EP. Finally, the product was dried in an oven for one night. A brown powder was obtained (I-A), characterised by infrared spectroscopy (FIG. 3).

The IR spectrum in FIG. 3 shows the formation of urethane bonds, indicated by the presence of stretching N—H (3310.7 cm⁻¹), C═O (1698.6 cm⁻¹), N—H and C—N (1530.9 cm⁻¹) and C—O (1221.12 cm⁻¹). The signal at 2264.4 cm⁻¹ shows the presence of residues of unreacted NCO.

### EXAMPLE 3 (I-B) (GER-IS1-BD-IS1-BD-IS1-GER)

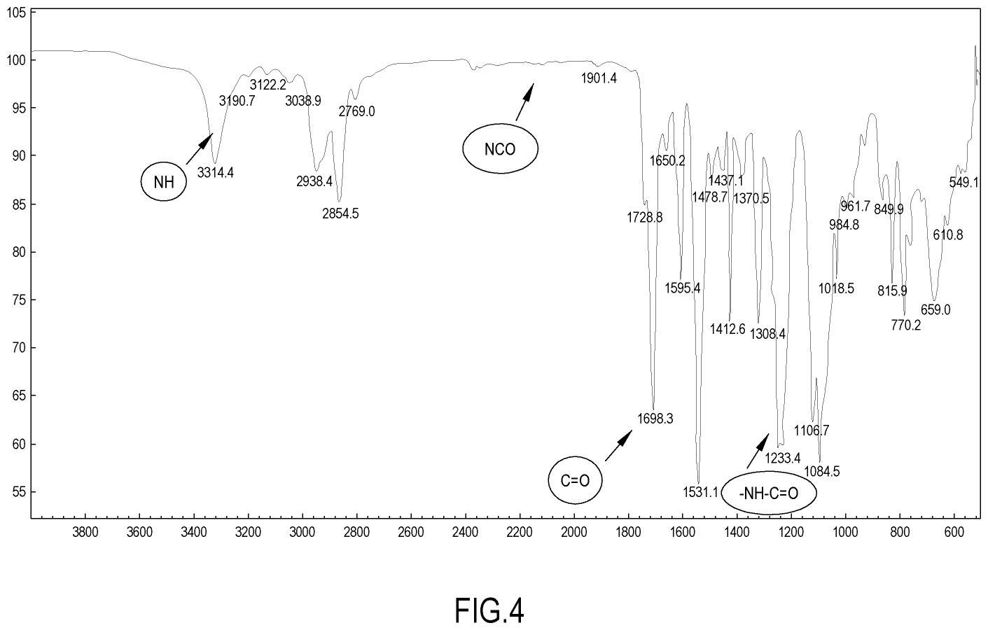

In a 100 ml flask with round bottom provided with magnetic stirrer, ISO 137 (II-B, 10 g, 0.022 mol) in 25 ml of cyrene and 1,4-butanediol (1.30 g, 0.014 mol) in 4 ml of cyrene were added. After 5 hours at 80° C., the reactive alcohol geraniol (IV-B) (2.22 g, 0.014 mol) was added dropwise in 6 ml of cyrene. The molar ratio isocyanate groups:OH groups brought by the diol:OH groups brought by the reactive alcohol was 1.5:1:0.5. The reaction was left under stirring for 12 hours at 80° C. After this time, the product (I-B) was precipitated in water, filtered under vacuum on Buchner and newly washed with methanol. Finally, the product was dried in an oven for one night. A light yellow powder was obtained, characterised by infrared spectroscopy. The FTIR spectrum in FIG. 4 shows the formation of urethane bonds, indicated by the presence of stretching N—H (3314.5 cm⁻¹), C═O (1696.3 cm⁻¹), N—H and C—N (1530.9 cm⁻¹) and C—O (1221.12 cm⁻¹). The signal at 2300.4 cm⁻¹ shows the presence of a small quantity of unreacted NCO.

### EXAMPLE 4 (I-C) (EP-IS1-BD-IS1-BD-IS1-EP)

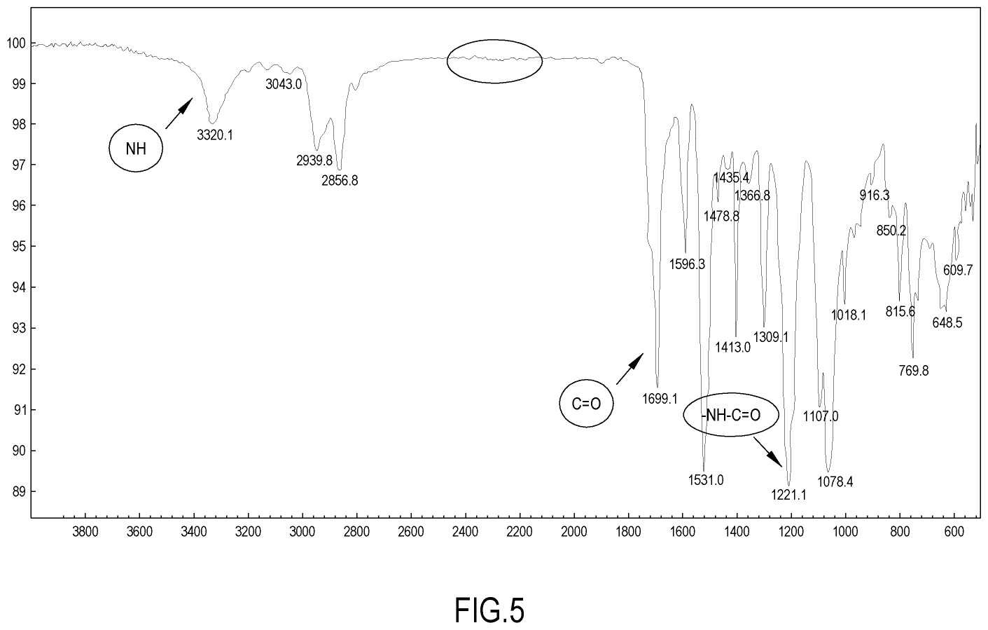

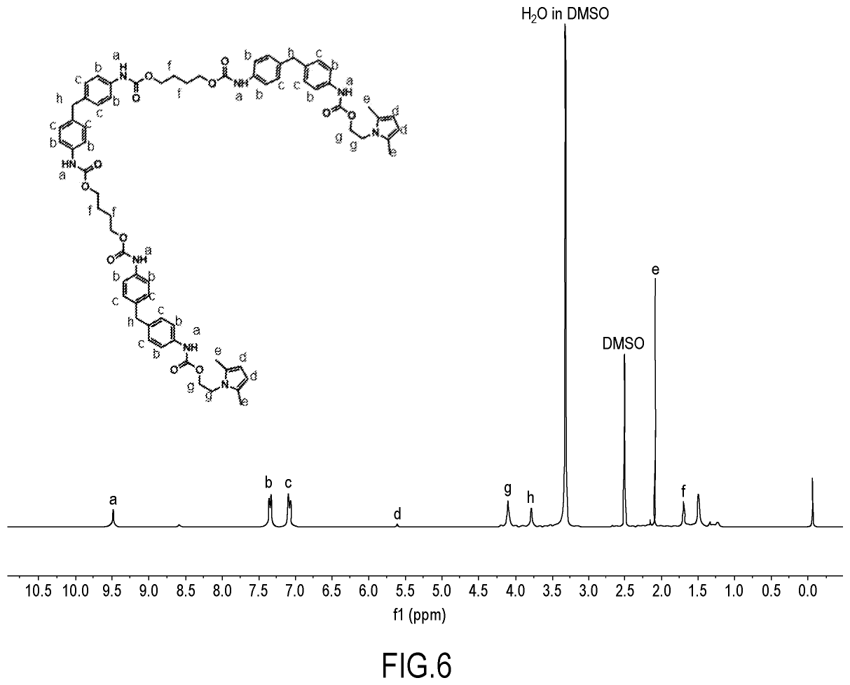

In a 100 ml flask with round bottom provided with magnetic stirrer, VORALAST GE143 (II-E, 10 g, 0.022 mol) in 25 ml of cyrene and 1,4-butanediol (1.30 g, 0.014 mol) in 4 ml of cyrene were added. After 5 hours at 80° C., the reactive alcohol ethanolpyrrol (IV-A) (2.25 g, 0.016 mol) was added dropwise in 6 ml of cyrene. The molar ratio isocyanate groups:OH groups brought by the diol:OH groups brought by the reactive alcohol was 1.5:1:0.57. A small excess of EP was used in order to prevent, at the end of the reaction, the presence of free NCO groups, monitoring the disappearance through IR spectra. The reaction was left under stirring for 12 hours at 80° C. After this time, the product (I-B) was precipitated in water, filtered under vacuum on Buchner and newly washed with acetone in order to remove the unreacted ethanol pyrrole. Finally, the product was dried in an oven for one night. A brownish powder was obtained, characterised by ¹H-NMR 400 MHz (DMSO-d6, FIG. 6) and infrared spectroscopy (FIG. 5).

The FTIR spectrum in FIG. 5 shows the formation of urethane bonds, indicated by the presence of stretching N—H (3320.1 cm⁻¹), C—O (1699.1 cm⁻¹), N—H and C—N (1530.9 cm⁻¹) and C—O (1221.12 cm⁻¹). There is no evidence of NCO residues.

### EXAMPLE 5 (I-D) (EP-IS2-BD-IS2-BD-IS2-EP)

In a 100 ml flask with round bottom provided with magnetic stirrer, hexamethylene diisocyanate (HDI, II-C, 10 g, 0.059 mol) and 1,4-butanediol (3.54 g, 0.039 mol) in 95 ml of cyrene were added. The reaction was left under stirring at 80° C. per 5 hours after which the reactive alcohol (IV-A) ethanol pyrrole (5.96 g, 0.043 mol) was added dropwise in 5 ml of cyrene. The reaction mixture was left under stirring at 80° C. for one night.

The molar ratio isocyanate groups:OH groups brought by the diol:OH groups brought by the reactive alcohol was 1.5:1:0.55. A small excess of reactive alcohol was used in order to have a complete reaction between the groups —OH and —NCO, confirmed by the IR analysis of the specimens.

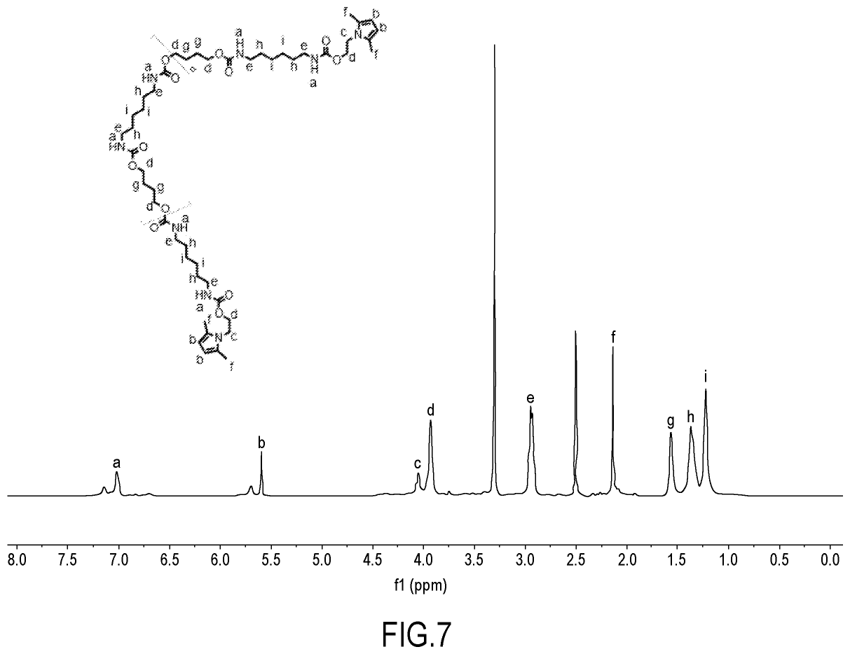

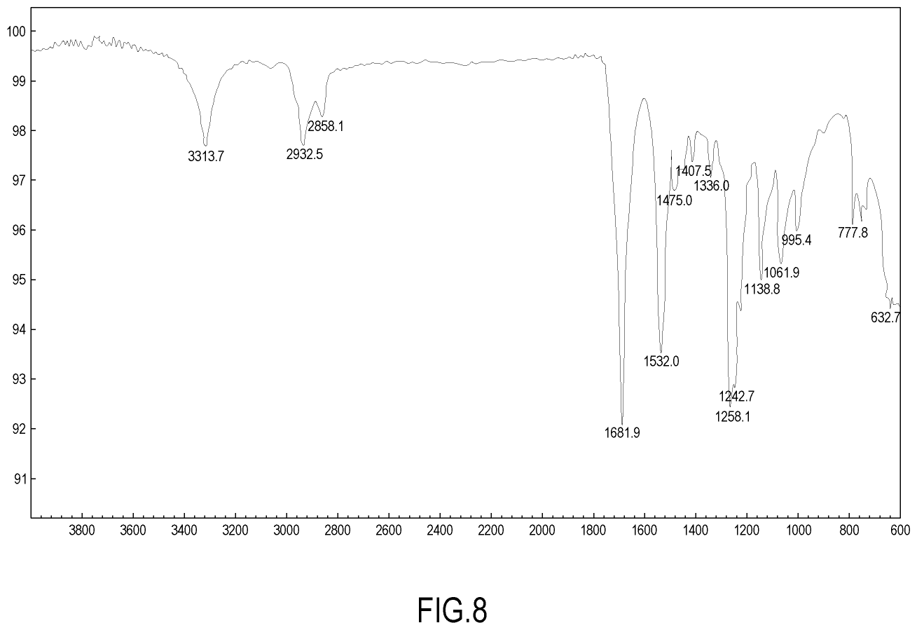

Once the reaction has completed, the product (I-D) was precipitated in water, filtered under vacuum on Buchner and newly washed with acetone in order to remove the unreacted alcohol. Finally, the product was dried in an oven for one night. A brownish powder was obtained, characterised by 1H-NMR 400 MHz (FIG. 7) and infrared spectroscopy (FIG. 8).

The peaks of the spectrum 1H-NMR (FIG. 7) are in accordance with the theoretical structure. The urethane —NH protons appear at 7.0 ppm while the CH2 protons of the aliphatic chain of the isocyanate (HDI) are visible at 3.0, 1.35 and 1.22 ppm. The signals of the aromatic hydrogens of the pyrrol ring are visible at 5.59 ppm, at 4.05 and 3.93 ppm (signals of protons CH2 close to N and O, respectively), at 2.13 ppm (hydrogens of the methyl groups in position α of the pyrrol ring). The CH2 protons of the 1,4-butanediol appear around 3.0 ppm (hydrogens of the groups CH2 close to the urethane groups) and 1.5 ppm.

The product (I-D) softened at 170°° C. and was soluble in DMSO.

### EXAMPLE 6 (I-E) (GER-IS2-BD-IS2-BD-IS2-GER)

In a 100 ml flask with round bottom provided with magnetic stirrer, hexamethylene diisocyanate (HDI, II-C, 10 g, 0.059 mol) and 1,4-butanediol (3.54 g, 0.039 mol) in 95 ml of cyrene were added. The reaction was left under stirring at 80° C. per 5 hours after which the reactive alcohol (IV-B) geraniol (6.62 g, 0.043 mol) was added dropwise in 5 ml of cyrene. The reaction mixture was left under stirring at 80° C. for one night.

The molar ratio isocyanate groups:OH groups brought by the diol:OH groups brought by the reactive alcohol era 1.5:1:0.55. A small excess of reactive alcohol was used in order to have a complete reaction between the —OH and —NCO groups, confirmed by the IR analysis of the specimens.

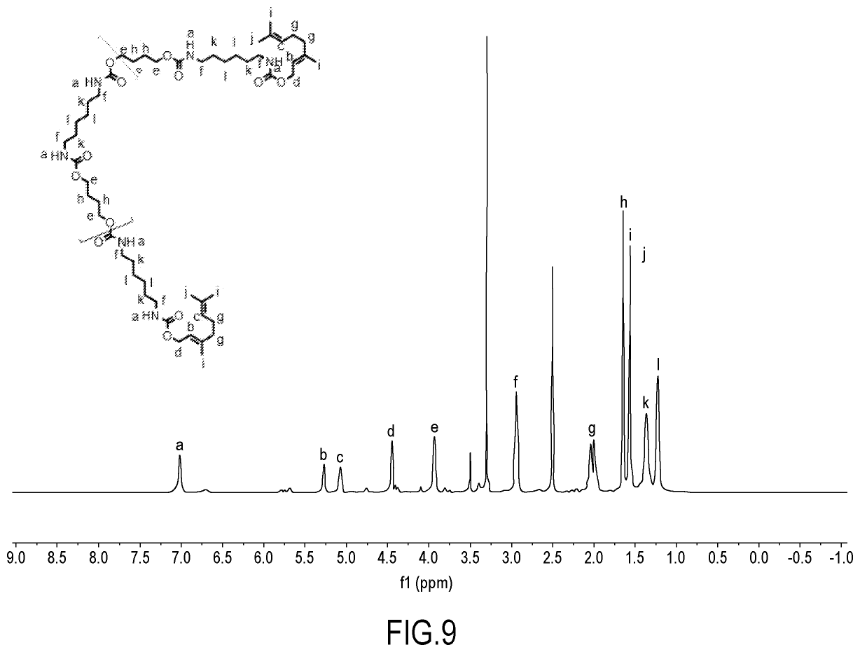

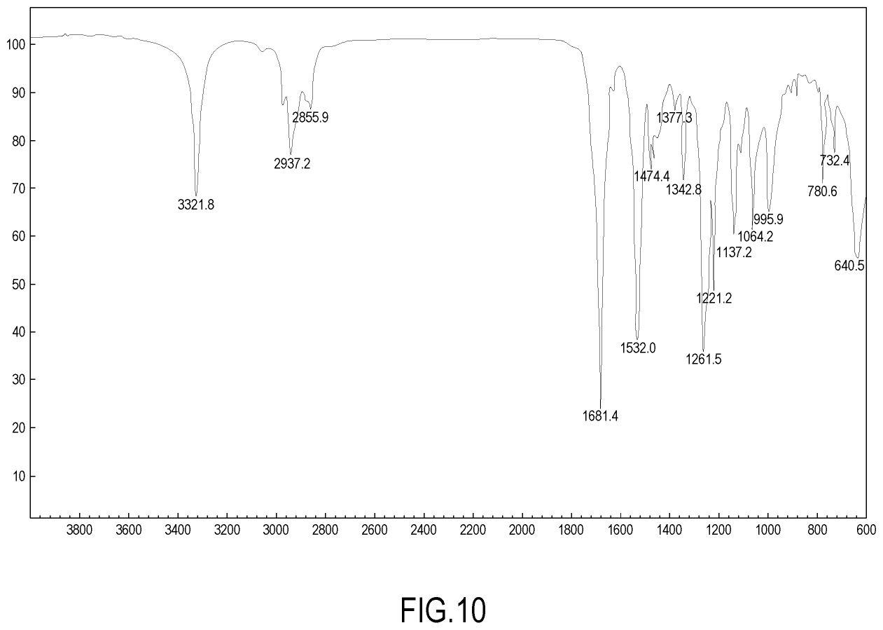

Once the reaction is completed, the product (I-E) was precipitated in water, filtered under vacuum on Buchner and newly washed with methanol in order to remove the unreacted alcohol. Finally, the product was dried in an oven for one night. A light yellow wax-like product, characterised by ¹H-NMR 400 MHz (FIG. 9) and infrared spectroscopy (FIG. 10), was obtained.

The peaks of the spectrum ¹H-NMR of the FIG. 9 (400 MHz, DMSO-d₆) are in accordance with the theoretical structure. The urethane —NH protons appear at 7.0 ppm while the CH2 protons of the aliphatic chain of the isocyanate (HDI) are visible at 3.0, 1.35 and 1.22 ppm. The characteristic signals of geraniol are at 5.27 and 5.0 ppm (vinyl protons), the CH2 protons at 4.4 ppm (close to the urethane group) and 2.0 ppm, the CH3 protons at about 1.5 ppm.

The CH2 protons of the 1,4-butanediol appear around 3.0 ppm (hydrogens of the CH2 groups close to the urethane groups) and 1.5 ppm.

The product (I-E) melted at 160° C. and was soluble in DMSO, THF, EtOAc, DMF and cyrene.

Synthesis of the terminated oligomers (I): formation of the pre-polymer and its reaction with the reactive alcohol in the absence of solvent (in bulk).

### EXAMPLE 7 (I-F) (GER-IS1-BD-IS1-GER)

In a 300 ml becher, the geraniol (59.57 g, 0.385 mol), butanediol (DIPRANE™ C Polyol by DOW, 17.36 g, 0.193 mol) and the catalyst (DIPRANE™ LC 1021 by DOW, 3 g, 0.5%) were weighed and mixed at 1000-1200 rpm for 15-20 seconds. Subsequently, diisocyanate HYPERLAST™ LE 5046 (123.23 g, 0.385 mol) was added to the mixture and mixed at 1000-1200 rpm for 20-30 seconds.

The molar ratio isocyanate groups:OH groups brought by the diol:OH groups brought by the reactive alcohol was 2:1:1

The reaction was observed to be quite exothermic (T max=140-160° C.).

The post-thermal treatment at 24 h at 100° C., followed by 30 min at 150° C. in order to eliminate any residual isocyanate, led to a product that was analytically lacking isocyanic groups (IR characterisation).

The product (I-F) melted at 160° C., was soluble in DMF and acetone and had a density of 1.17g/cm³.

### EXAMPLE 8 (I-F) (GER-IS1-BD-IS1-GER)

The same procedure of Example 7 was used, but also zeolite (6 g) as water absorbent was added as a precaution.

The product (I-F), characterised by IR, melted at 150° C. and was soluble in DMSO, DMF and acetone.

### EXAMPLE 9 (I-F) (GER-IS1-BD-IS1-GER)

The reactions for the preparation of the Examples 7 and 8 were observed to be very exothermic. For this reason the specimen of the present example was prepared as in Example 8 in the presence of zeolite (6 g) but without catalyst.

The product (I-F), characterised by IR, softened at 150° C. and was soluble in DMSO, AcOEt, DMF and acetone.

### EXAMPLE 10 (I-B) (GER-IS1-BD-IS1-BD-IS1-GER)

In a 300 ml becher, the following were weighed: geraniol (42.6 g, 0.276 mol), butanediol (24.9 g, 0.276 mol) and zeolite (6 g), as absorbent of the water, and mixed at 1000-1200 rpm for 15-20 seconds.

Following the mixing, the diisocyanate HYPERLAST™ LE 5046 (132.52 g, 0.414 mol) was added and mixed at 1000-1200 rpm for 20-30 seconds.

The molar ratio isocyanate groups:OH groups brought by the diol:OH groups brought by the reactive alcohol era 1.5:1:0.5.

The reaction was observed to be very exothermic (T max=140° C.).

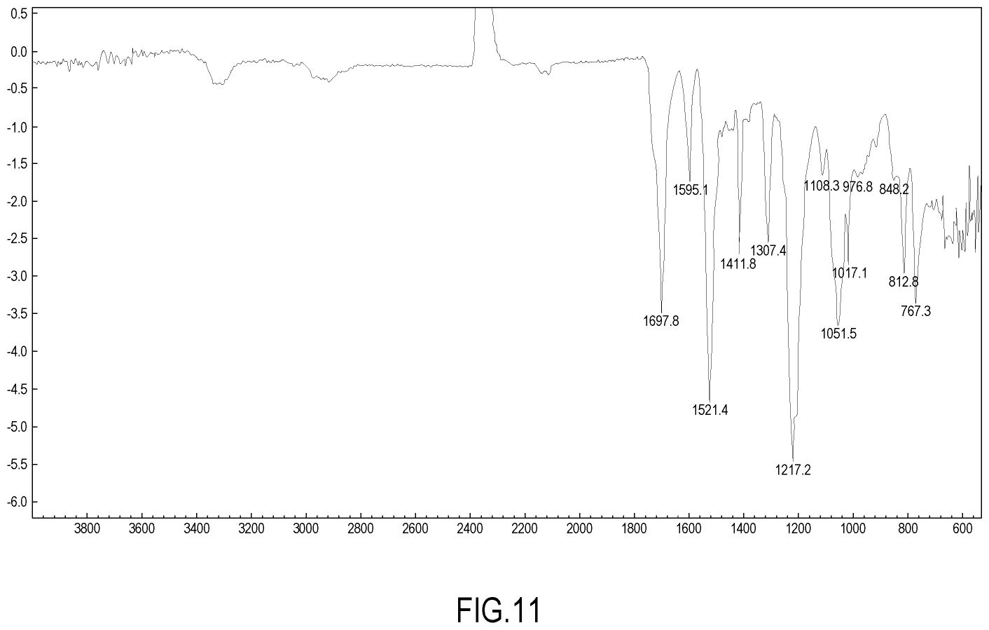

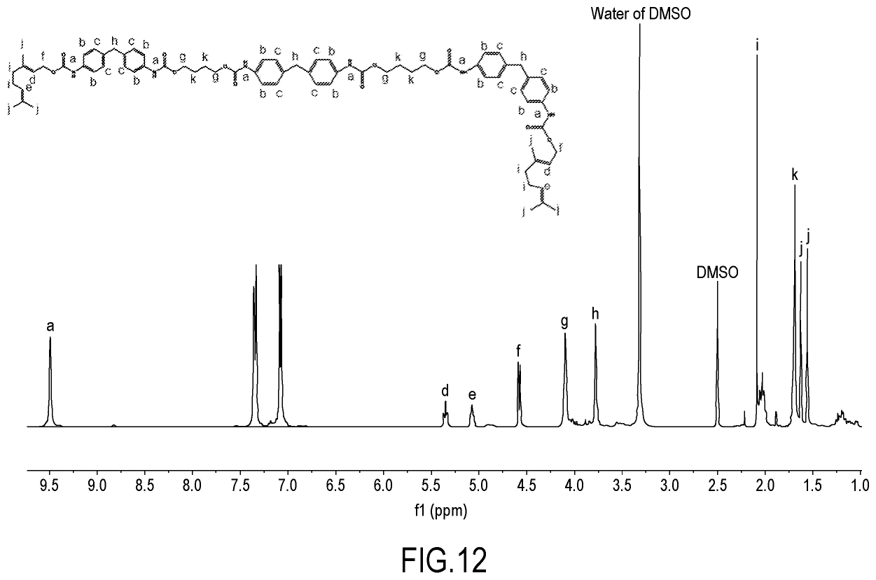

A powder was obtained (I-B), characterised by infrared spectroscopy (FIG. 11) and ¹H-NMR (400 MHz, DMSO-d₆) (FIG. 12).

The product (I-B) softened at 170° C. and was soluble in DMSO and DMF.

Upon IR analysis (FIG. 11), one saw the formation of urethane bonds, indicated by the presence of stretching N—H (3318.1 cm⁻¹), C═O (1695.5 cm⁻¹), N—H and C—N (1530.9 cm⁻¹) and C—O (1221.12 cm⁻¹) and the presence of residue NCO (around 2100 cm⁻¹).

### EXAMPLE 11 (I-B) (GER-IS1-BD-IS1-BD-IS1-GER)

The same preparation described in Example 10 was repeated, except that the addition of the isocyanate was carried out after 10 minutes. No significant change was observed.

### EXAMPLE 12 (I-G) (GER-IS1-(GLC-BD)-IS1-(GLC-BD)-IS1-GER)

The same preparation described in Example 10 was repeated, using as diol a mixture of butanediol (22.5 g, 0.25 mol) and glycerol (1.7 g, 0.018 mol) instead of only butanediol (the moles of OH brought by the mixture corresponded to those brought by the butanediol on its own of example 10). The molar ratio isocyanate groups:OH groups brought by the mixture of polyols:OH groups brought by the reactive alcohol was 1.5:1:0.5.

The reaction was observed to be very exothermic (T max=140° C.).

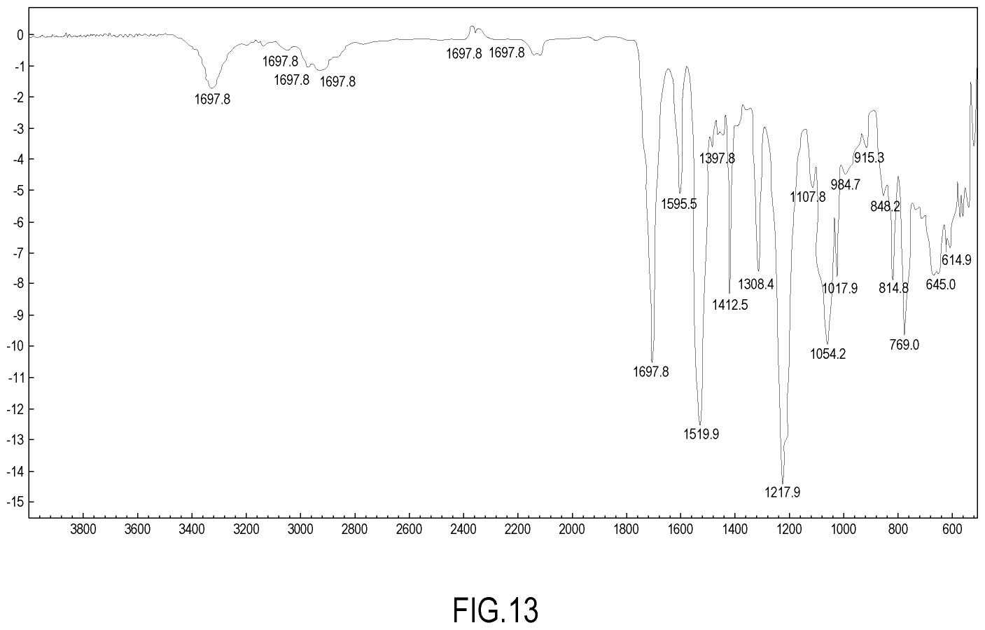

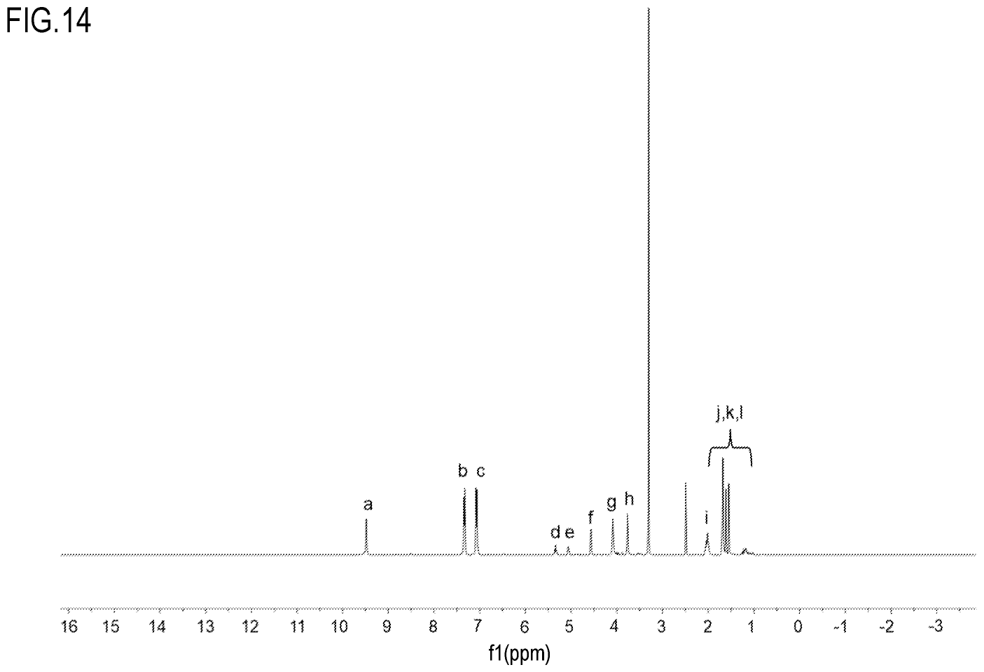

A powder was observed (I-G), characterised by infrared spectroscopy (FIGS. 13) and ¹H-NMR (400 MHz, DMSO-d6) (FIG. 14).

The product obtained I-G softened at 160° C. and was soluble in DMSO and DMF.

### EXAMPLE 13: PREPARATION OF ELASTOMERIC COMPOUNDS

Elastomeric compounds with reference isoprene base (13A) or according to the invention (13B and 13C) were prepared starting from the following compositions:

TABLE 3

| | Ex. 13A | Ex. 13B | Ex. 13C |
|---|---|---|---|
| phr | Reference | Invention | Invention |
| IR (SKI 3) | 100.00 | 100.00 | 100.00 |
| CB N326 | 50.00 | 40.00 | 40.00 |
| GER-IS1-BD- | 0.00 | 10.00 | 0.00 |
| IS1-GER (I-F) | | | |
| EP-IS1-BD-IS1- | 0.00 | 0.00 | 10.00 |
| BD-IS1-EP (I-C) | | | |
| Stearic acid | 1.50 | 1.50 | 1.50 |
| ZnO | 5.00 | 5.00 | 5.00 |
| 6PPD | 2.00 | 2.00 | 2.00 |
| TBBS | 1.50 | 1.50 | 1.50 |
| Sulphur | 4.00 | 4.00 | 4.00 |

in which
IR (SKI 3) is a natural rubber by PJSC Nizhnekamskneftekhim,
CB N326 is carbon black by Cabot Corporation, density: 1.8 g/cm³,
GER-IS1-BD-IS1-GER (I-F) is the terminated oligomer of the invention prepared in Example 7,
EP-IS1-BD-IS1-BD-IS1-EP (I-C) is the terminated oligomer of the invention prepared in Example 4,
Stearic acid: stearic acid by Undesa,
ZnO: Zinc oxide by Zincol Ossidi,
6PPD: N-(1,3-dimethylbutyl)-N′-phenyl-p-phenylenediamine, by Solutia Eastman, TBBS by LANXESS Chemical (China) Co. Ltd.
sulphur at 67% by weight in 33% oil, by Sulphur, Redball Superfine, International Sulphur Inc.

In the compositions according to the invention, 10 phr of conventional filler (carbon black) were substituted with 10 phr of (poly)urethane fillers (I) according to the invention.

The elastomeric compounds 13A-13C were prepared starting from the corresponding elastomeric compositions shown in Table 3 according to the following process.

The mixing of the components was carried out in two steps, using an internal mixer (Banbury, Intermix or Brabender).

In the first step (1), all the ingredients were introduced, including the terminated oligomers (1) of the invention, except for the vulcanising agents and the accelerants. The mixing was prolonged for a maximum time of 5 minutes, reaching a temperature of approximately 145° C.

Subsequently, in the second step (2), always carried out by using an internal mixer, the vulcanising agents were added together with the accelerants and other possible adjuvants and the mixing was prolonged for about 4 minutes, maintaining the temperature below 100° C. The compounds were then unloaded.

After cooling and at least 12 hours from the preparation, specimens of the compounds were vulcanised in a press at 170° C. for 10 min to give test specimens useful for the mechanical characterisations.

The rheological, dynamic and static mechanical properties of the elastomeric compounds of the reference and according to the invention were measured according to the above-described methods.

The results of these measurements were reported in the following Tables 4 and 5.

TABLE 4
rheological properties

| | Compound | | |
|---|---|---|---|
| | 13A | 13B | 13C |
| | Reference | Invention | Invention |
| | Reinforcing filler | | |
| | | Carbon black + | Carbon black + |
| | | GER-IS1-BD- | EP-IS1-BD-IS1- |
| | Carbon | IS1-GER | BD-IS1-EP |
| | black | (I-F) | (I-C) |
| M_{H} (dNm) | 18.61 | 12.03 | 13.44 |
| M_{L} (dNm) | 2.42 | 1.81 | 2.32 |
| M_{H} − M_{L} | 16.19 | 10.22 | 11.12 |
| (dNm) | | | |
| T₉₀ (min) | 3.64 | 3.62 | 3.67 |
| S′at T_{S1} (dNm) | 2.28 | 2.28 | 2.29 |
| S′ at T_{S2} (dNm) | 2.47 | 2.53 | 2.46 |

From the measurement of the rheological properties (170° C., 10 minutes), a certain difference is observed between the reference compound 13A, containing only carbon black, and the compounds according to the invention 13B and 13C, wherein 10 phr of carbon black were respectively substituted with 10 phr of terminated oligomer (I-F) and (I-C).

Indeed the values of MH and MH-ML fell more than 30% in accordance with the fact that at 170° C., the rigid urethane phase softened and acted more as a plasticiser than reinforcement.

The kinetics however did not appear significantly altered, as shown from the value of t90 substantially in line.

TABLE 5
dynamic properties

| | Compound | | |
|---|---|---|---|
| | 13A | 13B | 13C |
| | Reference | Invention | Invention |
| | Reinforcing filler | | |
| | | Carbon black + | Carbon black + |
| | | GER-IS1-BD- | EP-IS1-BD-IS1- |
| | Carbon | IS1-GER | BD-IS1-EP |
| | black | (I-F) | (I-C) |
| E′ 23° C. (MPa) | 5.46 | 5.63 | 5.63 |
| Tan Delta 23° C. | 0.18 | 0.17 | 0.15 |
| E′ 70° C. (MPa) | 4.96 | 4.60 | 4.92 |
| Tan Delta 70° C. | 0.11 | 0.12 | 0.09 |

From the dynamic data at 23° C., one observed a drop of hysteresis between the reference compound 13A and both compounds according to the invention 13B and 13C. Also at 70° C., at least in the case of the compound 13C comprising the terminated oligomer (I-C) (EP-IS1-BD-IS1-BD-IS1-EP), the hysteresis remained lower than that of the reference compound 13A comprising only carbon black.

Given that the hysteresis at 70° C. is considered to be a predictor of the rolling resistance of the tyre, it is possible to conclude that the terminated oligomer (I) of the invention could advantageously be used in tyre components, including in the tread band, in order to confer smaller rolling resistance and, not least, in order to limit the vehicle consumption.

The above-reported dynamic data confirms that the terminated oligomers (I) of the invention actually interact with the elastomeric phase and, even if present in minimal quantities (10 phr), they advantageously affect the properties thereof, in particular the hysteresis.

The compound comprising the filler of the invention (I-C) in particular is distinguished, having an E′ in line with the reference compound and a lower hysteresis both at 23° C. and at 70° C.

For the sake of completeness, also the statistical data of the compounds according to the invention were verified with respect to the comparison compound, data that were found to be entirely acceptable for use in tyres.

The densities of the reference compound of Example 13A and of the compound according to the invention of Example 13B are reported in the following Table 6

TABLE 6
density of the compounds

Compound

| | |
|---|---|
| 13A | 13B |
| Reference | Invention |

Reinforcing filler

| | | Carbon black + |
|---|---|---|
| | | GER-IS1-BD- |
| | Carbon | IS1-GER |
| | black | (I-F) |
| Density (g/cm³) | 1.120 | 1.096 |

These densities were calculated considering that, in the compound, the volumes of the components are additives, starting from the densities of the single components. As can be observed from the data tables, in the compound according to the invention an already significant reduction of the density with respect to the reference compound with a substitution of only 10 phr of the conventional filler (carbon black) with the terminated oligomer of the invention can be seen.

Entirely analogous results were expected in the case of terminated (poly)urea oligomers (I) according to the invention. The polyurethanes and the polyureas are copolymers well-known to have very similar behaviour, as appears for example from WO2021/202635A1, where in the formula VII of the preferred compounds (pages 2 and 3):

$$[ UPy - {( {D}_{m} - U - {D}_{m} )}_{( 2 + q )} ] - {[ {A ( G )}_{( n - 1 )} - {D}_{m} ]}_{k} - Z \qquad ( VII )$$

U can represent —NHCO—E— or —E—CONH—, comprising indiscriminately both urethanes (E═O) and ureas (E═NH, N-alkyl), or from texts that collectively discuss the polymers obtained from isocyanates, actually comprising the families deriving both from polyamines and from polyalcohols, such as for example in chapter 28 entitled “Isocyanate-Based Polymers: Polyurethanes, Polyureas, Polyisocyanurates, and their Copolymers” of the book Brydson's Plastics Materials (Eighth Edition) 2017, Pages 799-835.

In conclusion, from the experimental evidence it resulted that the terminated oligomer (I) according to the invention allowed reducing the weight of the elastomeric compounds where it was incorporated considerably, substantially maintaining the static properties and unexpectedly improving the dynamic performances, in particular the hysteresis, predictive in the tyre of a reduction of the rolling resistance and, in motion, of more limited consumptions and improved driving performances.

1-16. (canceled)

17. A terminated (poly)urethane, (poly)urea, or (poly)urethane and (poly)urea oligomer (I) suitable as reinforcing material for an elastomeric tyre compound,
wherein the terminated (poly)urethane, (poly)urea oligomer, or (poly)urethane and (poly)urea oligomer (I) is obtained by reaction of:
at least one polyisocyanate (II),
at least one polyol (III-I), one polyamine (III-II), or one polyol (III-I) and one polyamine (III-II) with molecular weight lower than 400 g/mol,
wherein polyisocyanate (II) and polyol (III-I), polyamine (III-II), or polyol (III-I) and polyamine (III-II) are used in the reaction in quantities to provide isocyanate groups and hydroxyl, amino, or hydroxyl and amino groups in molar ratio of isocyanate groups to hydroxyl, amino, or hydroxyl and amino groups ranging from 3:1 to 1.1:1, and to contribute no more than 5000 g/mol to the weight average molecular weight (MW) of the terminated oligomer (I), and
at least one monoalcohol or at least one monoamine of formula (IV):
X—Y—H (IV)
wherein
X is an organic residue comprising at least one reactive group capable of covalently binding to the diene polymers of the elastomeric compound under vulcanisation conditions or at least one hydrophobic group with high affinity for the diene polymers; and
Y is —O— or —NR2— , wherein R2 is selected from H, C₁-C₁₈, linear or branched, saturated or unsaturated alkyl, optionally substituted C₅-C₆ cycloalkyl, an aromatic group, optionally substituted by one or more linear or branched C₁-C₁₈, a heteroaromatic group comprising from 1 to 3 heteroatoms, optionally substituted by one or more C₁-C₁₈, linear or branched, saturated or unsaturated alkyls,
wherein, the terminated (poly)urethane, (poly)urea, (poly)urethane and (poly)urea oligomer (I) has a weight average molecular weight MW lower than 25000 g/mol measured by gel permeation chromatography.

18. The oligomer according to claim 17, wherein the Y groups are equal to each other and, optionally, the X groups are equal to each other.

19. The oligomer according to claim 17, wherein the compound of formula (IV) is a monoalcohol of formula (IV-I)
X—O—H (IV-I)
wherein
X is an organic residue comprising at least one reactive group capable of covalently binding to the diene polymers of the elastomeric compound under vulcanisation conditions or at least one hydrophobic group with high affinity for the diene polymers.

20. The oligomer according to claim 17, wherein the weight average molecular weight (MW) is lower than 20000 g/mol.

21. The oligomer according to claim 17, wherein the terminated (poly)urethane, (poly)urea, or (poly)urethane and (poly)urea oligomer (I) has a density lower than 1.40 g/cm³.

22. The oligomer according to claim 17, wherein the polyisocyanate (II) is selected from the group consisting of methylene diphenyl diisocyanate (MDI); tolylene 2,4- and/or 2,6-diisocyanate (TDI); hexamethylene 1,6-diisocyanate (HDI); pentamethylene 1,5-diisocyanate; methylene dicyclohexyl 4,4′, 2,4′- and/or 2,2′-diisocyanate (HMDI); isophorone diisocyanate (IPDI); and oligomers and mixtures thereof.

23. The oligomer according to claim 17, wherein the polyol (III-I), polyamine (III-II), or polyol (III-I) and polyamine (III-II) have a molecular weight lower than 200 g/mol.

24. The oligomer according to claim 17, wherein the X organic residue of the monoalcohol or of the monoamine of formula (IV) is selected from:
optionally substituted —C₂-C₁₈ alkenes, C₄-C₂₂ conjugated dienes, C₆-C₂₄ polyenes, or oligomers derived from the oligomerisation of at least one diene and, optionally, at least one monounsaturated comonomer, with molecular weight ranging from 200 g/mol to 5000 g/mol;
organic residues comprising at least one heterocycle reactive with the diene polymers or with the vulcanisation system of the elastomeric compound;
organic residues comprising at least one reactive sulphur group capable of directly binding with the diene polymer during the vulcanisation of the compound; and
hydrophobic groups selected from linear or branched in the alkyl portion, optionally substituted, C₆-C₂₄ alkyl, C₆-C₁₈ aryl, C₆-C₁₀ aryl —C₁-C₄ alkyl —C₆-C₁₀ aryl, C₁-C₈ alkyl —C₆-C₁₀ aryl —C₁-C₈ alkyl; and mixtures thereof.

25. The oligomer according to claim 17, wherein the terminated oligomer (I) is a terminated (poly)urethane oligomer of formula (I-II):
X—O—[(C═O)—NH—R—NH—(C═O)—O—R1—O]ₙ—(C═O)—NH—R—NH—(C═O)—O—X (I-II)
wherein
the organic residues X are equal to each other, and comprise a heterocycle, or an unsaturated residue,
R is, linear or branched in the alkylene portion, optionally substituted, C₂-C₁₄ alkylene or cycloalkylene, C₆-C₁₈ arylene, C₆-C₁₀ arylene —C₁-C₄ alkylene —C₆-C₁₀ arylene, C₁-C₄ alkylene —C₆-C₁₀ arylene —C₁-C₄ alkylene,
R1 is a linear or branched C₂-C₆ alkylene; and
n is a number from 1 to 3.

26. The oligomer according to claim 17, wherein the molar ratio between isocyanate groups of the polyisocyanate (II) and hydroxyl, amino, or hydroxyl and amino groups of the polyol (III-I), of the polyamine (III-II), or the polyol (III-I) and the polyamine (III-II) ranges from 2.5:1 to 1.1:1.

27. A composition for an elastomeric tyre compound comprising
100 phr of at least one diene polymer,
at least 1 phr of at least one terminated (poly)urethane, (poly)urea, or (poly)urethane and (poly)urea oligomer (I) according to claim 17, and
at least 0.1 phr of a vulcanising agent.

28. The composition according to claim 27, wherein the diene polymer is selected from natural or synthetic cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, and mixtures thereof; and/or
the vulcanising agent is selected from sulphur or sulphur donors.

29. An elastomeric tyre compound obtained by mixing and vulcanising the composition according to claim 27.

30. A tyre component for vehicle wheels comprising the elastomeric compound according to claim 29.

31. A tyre for vehicle wheels comprising the elastomeric compound according to claim 29 in at least one tyre component.

32. The tyre according to claim 31, wherein the tyre component is a tread band.
